(19) United States
(12) Patent Application Publication
(10) Pub. No.: US 2025/0102173 A1
(43) Pub. Date: Mar. 27, 2025

(54) SYSTEMS AND METHODS FOR PROVIDING ACTIONABLE RECOMMENDATIONS IN A FACILITY

(71) Applicant: HONEYWELL INTERNATIONAL INC., Charlotte, NC (US)

(72) Inventors: Jayalaxmi Telang, Bangalore (IN); Murugan Gopalan, Bangalore (IN)

(21) Appl. No.: 18/370,884

(22) Filed: Sep. 21, 2023

(51) Int. Cl. F24F 11/49; F24F 11/62; G06N 5/02

(52) U.S. Cl. CPC F24F 11/49; F24F 11/62; G06N 5/02

(57) ABSTRACT

Various embodiments described herein relate to systems and methods for providing actionable recommendations in a facility. In this regard, a first service case is generated in response to identification of a first event associated with a first asset in a facility. The first service case comprises at least one of: a first recommendation to resolve the first event and a first root cause to diagnose the first event. Further, the first service case is based on heuristic recommendations and heuristic knowledge for resolution of a plurality of service cases associated with at least one asset in the facility. A first input indicative of a resolution of the first service case is received. The first input has tagged information indicative of a modification to at least one of: the first recommendation and the first root cause. In response to receipt of the first input, a knowledge graph is updated based on the tagged information. The knowledge graph corresponds to a data model constructed for resolution of the plurality of service cases associated with the at least one asset in the facility. An occurrence of a second event associated with a second asset in the facility is identified. In this regard, the second event is related to the first event. A second service case is generated in response to identification of the second event. The second service case is generated based on the modification to at least one of: the first recommendation and the first root cause derived from the knowledge graph.

### TECHNICAL FIELD

The present disclosure generally relates to a facility management system. More particularly, the present disclosure relates to providing action based recommendations to manage assets in the facility.

### BACKGROUND

Often at times workers (e.g., a manager, an engineer, etc.,) with specialized domain knowledge are required to manage assets in a facility (e.g. a building facility, a warehouse, an industrial plant, and/or the like). Further, the assets are generally configured and monitored by the workers based on their knowledge, domain heuristics, or previously recorded (e.g. written) instructions. For example, configuration settings for a heating, ventilation, and air conditioning (HVAC) system and its maintenance activity is managed by a worker based on worker's domain knowledge with respect to the HVAC system and/or previous performance of that particular HVAC system. However, always managing assets based on worker domain knowledge or past recorded instructions has associated challenges. It often results in unoptimized management of assets and/or utilization of both electronic and human resources of the facility. Furthermore, in some cases, relying on worker and use of pre-defined instructions to manage an asset isn't effective, for instance, while predicting maintenance requirement of the assets and managing the assets accordingly on need basis. Accordingly, it becomes challenging to manage assets and processes in the facility.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 illustrates a schematic diagram showing a facility management system comprising multiple facilities, in accordance with one or more example embodiments described herein.

FIG. 2 illustrates a schematic diagram showing a building management system, in accordance with one or more example embodiments described herein.

FIG. 3 illustrates a schematic diagram showing a facility management system to manage multiple facility sites, in accordance with one or more example embodiments described herein.

FIG. 4 illustrates a schematic diagram showing a framework of an Internet-of-Things (IoT) platform utilized in a facility management system, in accordance with one or more example embodiments described herein.

FIG. 5 illustrates a schematic diagram showing an implementation of a controller that may execute techniques in accordance with one or more example embodiments described herein.

FIG. 6 illustrates a schematic diagram showing an implementation of a service case management system of a facility management system, in accordance with one or more example embodiments described herein.

FIG. 7 illustrates a schematic diagram showing an implementation of a governance component of a service case management system, in accordance with one or more example embodiments described herein.

FIG. 8A illustrates a schematic diagram showing an implementation of a facility management system comprising a governance component, in accordance with one or more example embodiments described herein.

FIG. 8B illustrates a schematic diagram showing an implementation of a facility management system, in accordance with one or more example embodiments described herein.

FIGS. 9A-9G illustrate schematic diagrams showing exemplary user interfaces of service case management system of a facility management system, in accordance with one or more example embodiments described herein.

FIG. 10 illustrates a flowchart showing a method described in accordance with some example embodiments described herein.

FIG. 11 illustrates a flowchart showing a method described in accordance with some example embodiments described herein.

FIG. 12 illustrates a flowchart showing a method described in accordance with some example embodiments described herein.

FIG. 13 illustrates a flowchart showing a method described in accordance with some example embodiments described herein.

FIG. 14 illustrates a flowchart showing a method described in accordance with some example embodiments described herein.

FIG. 15 illustrates a flowchart showing a method described in accordance with some example embodiments described herein.

### SUMMARY

The details of some embodiments of the subject matter described in this specification are set forth in the accompanying drawings and the description below. Other features, aspects, and advantages of the subject matter will become apparent from the description, the drawings, and the claims.

In accordance with an example embodiment, a method is described. In one or more example embodiments, the method comprises generating a first service case in response to identification of a first event associated with a first asset in a facility, wherein the first service case comprises at least one of: a first recommendation to resolve the first event and a first root cause to diagnose the first event, and wherein the first service case is based on heuristic recommendations and heuristic knowledge for resolution of a plurality of service cases associated with at least one asset in the facility. In one or more example embodiments, the method comprises receiving a first input indicative of a resolution of the first service case, wherein the first input comprises tagged information indicative of a modification to at least one of: the first recommendation and the first root cause. In one or more example embodiments, the method comprises updating a knowledge graph based on the tagged information, the knowledge graph corresponding to a data model constructed for resolution of the plurality of service cases associated with the at least one asset in the facility. In one or more example embodiments, the method comprises identifying occurrence of a second event associated with a second asset in the facility, the second event defining a relationship to the first event. In one or more example embodiments, the method comprises generating a second service case in response to identification of the second event based at least in part on the modification to at least one of: the first recommendation and the first root cause derived from the knowledge graph.

The above summary is provided merely for purposes of providing an overview of one or more exemplary embodiments described herein so as to provide a basic understanding of some aspects of the disclosure. Accordingly, it will be appreciated that the above-described embodiments are merely examples and should not be construed to narrow the scope or spirit of the disclosure in any way. It will be appreciated that the scope of the disclosure encompasses many potential embodiments in addition to those here summarized, some of which are further explained in the following description and its accompanying drawings.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims.

It is to be understood that both the foregoing general description and the following detailed description are exemplary and explanatory only and are not restrictive of the disclosed embodiments, as claimed.

### DETAILED DESCRIPTION OF THE DRAWINGS

Reference will now be made in detail to embodiments, examples of which are illustrated in the accompanying drawings. In the following detailed description, numerous specific details are set forth in order to provide a thorough understanding of the various described example embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments. The term “or” is used herein in both the alternative and conjunctive sense, unless otherwise indicated. The terms “illustrative,” “example,” and “exemplary” are used to be examples with no indication of quality level. Like numbers refer to like elements throughout.

The phrases “in an embodiment,” “in one embodiment,” “according to one embodiment,” and the like generally mean that the particular feature, structure, or characteristic following the phrase can be included in at least one example embodiment of the present disclosure, and can be included in more than one example embodiment of the present disclosure (importantly, such phrases do not necessarily refer to the same example embodiment).

The word “exemplary” is used herein to mean “serving as an example, instance, or illustration.” Any implementation described herein as “exemplary” is not necessarily to be construed as preferred or advantageous over other implementations. If the specification states a component or feature “can,” “may,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature can be optionally included in some example embodiments, or it can be excluded.

One or more example embodiments of the present disclosure may provide an “Internet-of-Things” or “IoT” platform for facility management that uses real-time accurate models and visual analytics to deliver recommendations that are actionable for sustained peak performance of the facility or the enterprise. The IoT platform is an extensible platform that is portable for deployment in any cloud or data center environment for providing an enterprise-wide, top to bottom view, displaying status of processes, assets, people, and/or safety. Further, the IoT platform of the present disclosure supports end-to-end capability to execute digital twins against process data and to translate the output into actionable recommendations, as detailed in the following description.

Facility management (e.g., a building, an industrial site, or a factory) is often performed by workers with specialized domain knowledge. For example, if issues like faults are observed in an asset, then skilled operators with sufficient domain knowledge associated with the asset are required. Such operators can identify root cause of the fault and take relevant measures to resolve the fault. However, the measures taken by the operators to identify the root cause and resolve the fault goes unobserved and unrecorded. In some instances, operators knowledge is subjected to aging and may become irrelevant to identify root cause of the fault. This leads to unaddressed and unresolved faults in the facility. Further, in some instances, the operators need to check multiple sources such as, but not limited to dashboards, building management applications, building management system (BMS) etc., to identify root cause of the fault. This makes root cause identification and fault resolution a time and cost intensive operation in the facility.

In some examples, personnel in the facility use traditional systems such as rule based engines for managing a facility. Rule based engines provide recommendations based on pre-defined rules to address issues observed in the facility. In some instances, the recommendations can be used by operators to resolve a fault observed in an asset in the facility. In some other instances, the recommendations can be used for predictive maintenance of an asset in the facility. However, these recommendations are static or fixed in nature. Further, the recommendations are based on historic data, pre-defined instructions which is subjected to aging and/or becoming obsolete or irrelevant over a period of time. So, these recommendations may not be useful to resolve a fault always, for instance, particularly in situations when a fault or event associated with an asset is unobserved or occurs for the first time. In addition, the traditional systems lack intuitiveness and intelligence to provide new recommendations, e.g. but not limited to, in near real-time, in order to address issues observed in the facility. Further, the recommendations may fail to provide accurate predictive maintenance for the asset. Therefore, asset management becomes challenging in the facility.

Thus, to address the above challenges, action based recommendations are provided by various examples of systems and methods described herein. In some instances, the recommendations can be utilized by personnel to manage a facility. In some examples, the recommendation can be associated with actions to be taken to improve overall operational performance of the facility. In some examples, the recommendation can be related to actions to be taken to manage assets in the facility. In some examples, the recommendation can be associated with improvement of efficiency of workers in the facility. Further, the recommendations can be utilized by a facility management system to make changes in the facility. For example, the facility management system can utilize the recommendations to change configuration of an asset in the facility. In some instances, the facility management system can change settings of a heating, ventilation and air conditioning (HVAC) system to maintain desired comfort levels in the facility. In some instances, the facility management system can change operational setpoint of an air handling unit (AHU) to set a discharge temperature of the AHU in the facility. In some instances, the facility management system can utilize the recommendations to generate a service case to resolve an issue in the facility. Accordingly, the recommendations provided herein drive better engagement of personnel to manage the facility. Further, the recommendations provided herein significantly reduce time taken by personnel to identify and resolve an issue in the facility. This enhances efficiency of personnel in the facility along with improved management of facility. In addition, the recommendations provided herein assist in timely identification of asset condition in the facility. Accordingly, the assets in the facility can be serviced and/or repaired in a timely manner. Further, the recommendations provided herein expedite resolution of issues associated with the assets. Thereby this results in mitigating downtime and preventing impact of a problem associated with the assets to flow down to other related assets in the facility. On an overall, the recommendations provided herein improve throughput of the facility.

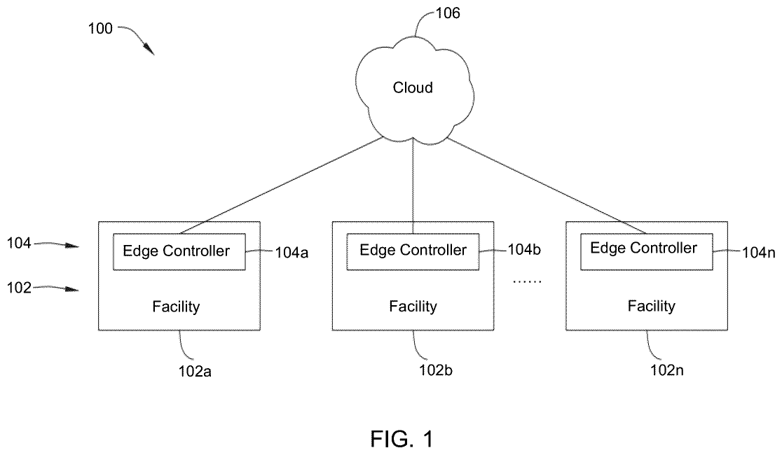

FIG. 1 illustrates a schematic diagram showing a facility management system comprising multiple facilities. In various example embodiments, a facility management system 100 may be used to facilitate data handling and various operational activities for one or more facilities 102a, 102b . . . 102n (collectively “facilities 102”). In some example embodiments, the illustrative facility management system 100 may be used to provide one or more actionable recommendations to manage the one or more facilities 102a, 102b . . . 102n. For instance, in an example, the facility management system 100 may generate a recommendation to make changes in the one or more facilities 102a, 102b . . . 102n. In some example embodiments, the recommendation may correspond to a change in configuration of asset settings in the one or more facilities 102a, 102b . . . 102n. In some example embodiments, the recommendation may correspond to a change in operational set point of an asset in the one or more facilities 102a, 102b . . . 102n. In another example, the facility management system 100 may generate a recommendation indicative of a service case for an asset in the one or more facilities 102a, 102b . . . 102n. In some example embodiments, the one or more facilities 102a, 102b . . . 102n may represent a building or part of a building. In some example embodiments, the one or more facilities 102a, 102b . . . 102n may represent an industrial process or part of an industrial process. In some example embodiments, the one or more facilities 102a, 102b . . . 102n may represent similar types of facilities. In some example embodiments, the one or more facilities 102a, 102b . . . 102n may represent different types of facilities e.g. a residential complex, a commercial building, an institutional building, a monument, an IT park, a corporate office, an airport premises, a tourist place and/or the like. As it may be understood, these facilities may include various electronic equipment, sensor system etc. (referred herein as assets and/or devices) for performing various operations within a facility. In some examples, these facilities may include thousands of sensor systems and its sub-systems which may operate in conjunction to run one or more operations of the facility premises. In this regard, these assets may perform several data transactions and exchange large data files in various formats amongst each other using plurality of data communication protocols.

In an example embodiment, a cloud 106 is operably coupled with one or more facilities 102a, 102b . . . 102n, meaning that communication between the cloud 106 and one or more facilities 102a, 102b . . . 102n is enabled. The cloud 106 may represent distributed computing resources, software, platform or infrastructure services which can enable data handling, data processing, data management, and/or analytical operations on the data exchanged & transacted amongst the various assets of the facilities 102. In this regard, in accordance with some example embodiments, operational data such as telemetry data (e.g. sensor data) and optionally associated metadata (e.g. contextual information associated with sensor data) can be uploaded to the cloud 106 for processing. In some example embodiments, the operational data may be associated with assets situated in the one or more facilities 102a, 102b . . . 102n. In some examples, the cloud 106 may receive and/or transact operational data (OT data) and information technology (IT) enabled data through the facilities 102. In some examples, the OT data may represent telemetry data. Telemetry data can include time stamps and data values corresponding to those time stamps. In other words, telemetry data can represent data collected over a period of time (e.g. continuous data stream captured over a time period) from various assets (e.g. sensors, IoT network) of the facility. In this regard, in accordance with some example embodiments, the recommendations may be generated by the cloud 106 based on processing and modelling of operational data associated with an asset.

In an example embodiment, the cloud 106 includes one or more servers that may be programmed to communicate with the one or more facilities 102a, 102b . . . 102n and to exchange data as appropriate. The cloud 106 may be a single computer server or may include a plurality of computer servers. In some example embodiments, the cloud 106 may represent a hierarchal arrangement of two or more computer servers, where perhaps a lower level computer server (or servers) processes telemetry data, for example, while a higher-level computer server oversees operation of the lower level computer server or servers.

The one or more facilities 102a, 102b . . . 102n may include a variety of different assets. In an example embodiment, the one or more facilities 102a, 102b . . . 102n may include a variety of different assets, at least some of which are of same type. In an example embodiment, the one or more facilities 102a, 102b . . . 102n may include a variety of different assets, at least some of which are of different type. In the example shown in FIG. 1, each of the one or more facilities 102a, 102b . . . 102n includes a respective edge controller 104a, 104b . . . 104n (collectively “edge controllers 104”). In an example embodiment, each of one or more edge controllers 104a, 104b . . . 104n is configured to receive data from a variety of assets within the one or more facilities 102a, 102b . . . 102n. In some examples, the one or more edge controllers 104a, 104b . . . 104n may operate as intermediary node to transact data through one or more assets of the facility and/or to the cloud 106. In some examples, each of the one or more edge controllers 104a, 104b . . . 104n is capable of receiving the data from disparate data sources e.g., but not limited to, in different data formats and/or using various data communication protocols, from plurality of assets of the facility. In this regard, each of the one or more edge controllers 104a, 104b . . . 104n can receive & filter telemetry data and translate the telemetry data into a common language and/or format (e.g. normalized data) for subsequent communication to the cloud 106. The common language and/or format may be compatible with and expected by the cloud 106.

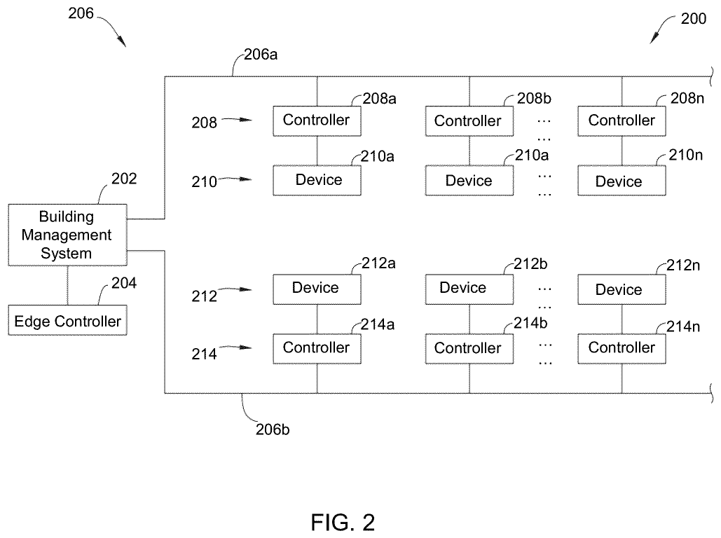

FIG. 2 illustrates a schematic diagram showing a building management system. In various example embodiments, an example facility 200 of FIG. 2 may comprise assets communicatively coupled via multiple networks 206 (e.g. communication channels). For instance, as illustrated in FIG. 2, the facility 200 may include a first network 206a and a second network 206b. In an example embodiment, the facility 200 may include only a single network 206. In an example embodiment, the facility 200 may include multiple networks 206. Each of the networks 206 may include any available network infrastructure. In an example embodiment, each of the networks 206 may independently be, for example, a BACnet network, a NIAGARA network, a NIAGARA CLOUD network, or others. Accordingly, in some example embodiments, the facility 200 may comprise a plurality of assets and/or devices in communication with the building management system 202 via corresponding communication channel (e.g. networks 206a and/or 206b). Said differently, each of the network may represent a sub-network supported by an underlined network communication/IoT protocol and incorporating a cluster of end-points (e.g. assets, controllers etc. in building facility).

In an example embodiment, one or more first devices 210a, 210b, . . . 210n (collectively “first devices 210”) are operably coupled to the first network 206a via one or more first controllers 208a, 208b, . . . 208n (collectively “first controllers 208”). The one or more first devices 210a, 210b, . . . 210n may represent a variety of different types of assets that may be found within the facility 200. In an example embodiment, at least some of the one or more first devices 210a, 210b, . . . 210n are building management system components. Examples of building management system components may be, but not limited to sensors, actuators, valves, etc. In another example embodiment, at least some of the one or more first devices 210a, 210b, . . . 210n are equipment within a factory. In another example embodiment, at least some of the one or more first devices 210a, 210b, . . . 210n are industrial process control devices within an industrial process.

In an example embodiment, one or more first controllers 208a, 208b, . . . 208n controls operation of at least one of the one or more first devices 210a, 210b, . . . 210n. In some example embodiments, the one or more first controllers 208a, 208b, . . . 208n can transact telemetry data that can be processed and/or analyzed to generate one or more recommendations for the one or more first devices 210a, 210b, . . . 210n. Further, in some example embodiments, the one or more first controllers 208a, 208b, . . . 208n may enable implementation of the one or more recommendations generated for the one or more first devices 210a, 210b, . . . 210n of the facility 200. In some example embodiments, the one or more recommendations may correspond to one or more service cases for maintaining the one or more first devices 210a, 210b, . . . 210n. In some example embodiments, the one or more recommendations may correspond to settings for configuring the one or more first devices 210a, 210b, . . . 210n. In another example embodiment, the one or more first controllers 208a, 208b, . . . 208n may be built into one or more of the corresponding one or more first devices 210a, 210b, . . . 210n, and may not be a separate component. In another example embodiment, the one or more first controllers 208a, 208b, . . . 208n may be virtual controllers that may be implemented within a virtual environment hosted by one or more computing devices (not illustrated). The one or more first controllers 208a, 208b, . . . 208n may be containerized. In another example embodiment, at least some of the one or more first devices 210a, 210b, . . . 210n may be controllers. In such case, the one or more first devices 210a, 210b, . . . 210n may not have a separate corresponding controller of the one or more first controllers 208a, 208b, . . . 208n.

In an example embodiment, one or more second devices 212a, 212b, . . . 212n (collectively “second devices 212”), are operably coupled to the second network 206b via one or more second controllers 214a, 214b, . . . 214n (collectively “second controllers 214”). The one or more second devices 212a, 212b, . . . 212n may represent any of a variety of different types of assets that may be found within the facility 200. In an example embodiment, at least some of the one or more second devices 212a, 212b, . . . 212n are building management system components. Examples of building management system components may be, but not limited to sensors, actuators, valves, etc. In another example embodiment, at least some of the one or more second devices 212a, 212b, . . . 212n are equipment within a factory. In another embodiment, at least some of the one or more second devices 212a, 212b, . . . 212n are industrial process control devices within an industrial process.

In another example embodiment, the one or more second controllers 214a, 214b, . . . 214n controls operation of at least one of the one or more second devices 212a, 212b, . . . 212n. In some example embodiments, the one or more second controllers 214a, 214b, . . . 214n can generate one or more recommendations for the one or more second devices 212a, 212b, . . . 212n. In some example embodiments, the one or more recommendations may correspond to one or more service cases for maintaining the one or more second devices 212a, 212b, . . . 212n. In some example embodiments, the one or more recommendations may correspond to settings for configuring the one or more second devices 212a, 212b, . . . 212n. In another example embodiment, the one or more second controllers 214a, 214b, . . . 214n may be built into one or more of the corresponding one or more second devices 212a, 212b, . . . 212n, and may not be a separate component. In another example embodiment, the one or more second controllers 214a, 214b, . . . 214n may be virtual controllers that may be implemented within a virtual environment hosted by one or more computing devices (not illustrated). In another example embodiment, at least some of the one or more second devices 212a, 212b, . . . 212n may be controllers. In such case, the one or more second devices 212a, 212b, . . . 212n may not have a separate corresponding controller of the one or more one or more second controllers 214a, 214b, . . . 214n.

In an example embodiment, the facility 200 may include a Building Management System (BMS) 202 that is operably coupled with the first network 206a and the second network 206b. In another example embodiment, the BMS 202 may be operably coupled with the first network 206a but not with the second network 206b. In another example embodiment, the BMS 202 may be operably coupled with the second network 206b but not with the first network 206a. In an example embodiment, the BMS 202 may be a legacy controller. In another example embodiment, the BMS 202 may be absent.

In an example embodiment, an edge controller 204 is installed within the facility 200. In some example embodiments, the edge controller 204 may be operably coupled with the BMS 202. The edge controller 204 may be considered as functioning as an intermediary between the first controllers 208, the second controllers 214, and the cloud 106. For instance, in an example, the edge controller 204 can pull data from the first controllers 208 and the second controllers 214 and provide the data to the cloud 106. In an example embodiment, the edge controller 204 is configured to discover the first devices 210, the second devices 212, the first controllers 208, and/or the second controllers 214 that are connected along a local network such as the network 206. In an example embodiment, the network protocol of the network 206 includes discovery commands that, for example, are used to request that all devices connected to the network 206 identify themselves. In some cases, the edge controller 204 is configured to discover the first devices 210 and the second devices 212 regardless of an underlaying protocol supported by the first devices 210 and the second devices 212. In other words, the edge controller 204 can discover the first devices 210 and the second devices 212 supported by different protocols (e.g. BACnet, Modbus, LonWorks, SNMP, MQTT, Foxs, OPC UA etc.).

In an example embodiment, the edge controller 204 interrogates any devices it finds operably coupled to the network 206 to obtain additional information from those devices that further helps the edge controller 204 and/or the cloud 106 identify the connected devices, such as type of building system components, functionality of the identified building system components, connectivity of the local controllers and/or building system components, types of operational data that is available from the local controllers and/or building system components, types of alarms that are available from the local controllers and/or building system components, and/or any other suitable information. For purpose of brevity, the additional information requested from the devices is referred interchangeably as, ‘metadata’, ‘semantic data’, or ‘the model data’, hereinafter throughout the description.

More generally, and in some example embodiments, the edge controller 204 may be communicatively coupled to one or more assets, via one or more networks. For purpose of brevity, the term ‘assets’ is also referred interchangeably to as ‘data points’, ‘end points’, ‘devices’, ‘sensors’, or ‘electronic devices’ throughout the description. According to various example embodiments described herein, the assets can be, for example, but not limited to, sensors, electronic components, pressure valves, HVACs, alarm units, building management systems, building controllers, industrial subsystems, industrial controllers, lightning systems, air detective systems, air quality sensors, etc. These may correspond to, for example, one or more of the first devices 210 and the second devices 212.

According to an example embodiment, the edge controller 204 is configured to receive at least one of, the telemetry data and model data from the one or more assets corresponding to various independent and diverse sub-systems in the facility 200 (e.g., but not limited to, a building, an industrial site, a vehicle, a warehouse etc.). The one or more assets correspond to various independent and diverse sub-systems in the facility 200. In some examples, the telemetry data can represent time-series data and may include a plurality of data values associated with the assets which can be collected over a period of time. For instance, in an example, the telemetry data may represent a plurality of sensor readings collected by a sensor over a period of time. Further, the model data can represent meta-data associated with the assets. The model data can be indicative of ancillary or contextual information associated with the asset. For instance, in an example, the model data can be representative of geographical information associated with the asset (e.g. location of the asset) within the facility 200. In another example, the model data can represent a sensor setting based on which a sensor is commissioned within a facility 200. In yet another example, the model data can be representative of a data type or a data format associated with the data transacted through the asset. In yet another example, the model data can be indicative of any information which can define a relationship of the asset with one or more other assets in the facility 200. In accordance with various example embodiments described herein, the term ‘model data’ can be referred interchangeably as ‘semantic model’ or ‘metadata’ for purpose of brevity.

In accordance with an example embodiment, the edge controller 204 is configured to discover and identify the one or more assets which are communicatively coupled to the edge controller 204. Further, upon identification of the assets, the example edge controller 204 is configured to pull the telemetry data and/or the model data from the various identified assets. In an example, these assets can correspond to one or more electronic devices that may be located on-premise in the facility 200. The edge controller 204 is configured to pull the data by sending one or more data interrogation requests to the one or more assets. These data interrogation requests can be based on a protocol supported by an underlying one or more assets.

In accordance with an example embodiment, the edge controller 204 is configured to receive the telemetry data and/or the model data in various data formats or different data structures. In an example, a format of the telemetry data and/or the model data, received at the edge controller 204 may be in accordance with a communication protocol of the network supporting transaction of data amongst two or more network nodes (i.e. the edge controller 204 and the asset). As can be appreciated, in some example embodiments, the various assets in the facility 200 can be supported by one or more of various network protocols (e.g., IOT protocols like BACnet, Modbus, LonWorks, SNMP, MQTT, Foxs, OPC UA etc.). Accordingly, and in some cases, the edge controller 204 is configured to pull the telemetry data and/or the model data, in accordance with communication protocol supported by the one or more assets.

In some example embodiments, the edge controller 204 is configured to process the received data and transform the data into a unified data format. The unified data format is referred hereinafter as a common object model. In an example, the common object model is in accordance with an object model that may be required by one or more data analytics applications or services, supported at the cloud 106. In some example embodiments, the edge controller 204 can perform data normalization to normalize the received data into a pre-defined data format. In an example, the pre-defined format can represent a common object model in which the edge controller 204 can further push the telemetry data and/or the model data to the cloud 106. In some example embodiments, the edge controller 204 is configured to establish a secure communication channel with the cloud 106. In this regard, the data can be transacted between the edge controller 204 and the cloud 106, via the secure communication channel. In some example embodiments, the edge controller 204 can send the data to the cloud 106 automatically at pre-defined time intervals. In some example embodiments, at least a part of the data can correspond to historic data.

In some example embodiments, the edge controller 204 and/or the cloud 106 can identify one or more events associated in the facility 200 based on the common object model. In some example embodiments, the one or more events may be associated with the one or more first devices 210a, 210b, . . . 210n or the one or more second devices 212a, 212b, . . . 212n in the facility 200. In some example embodiments, the one or more events may be associated with one or more processes in the facility 200. In some example embodiments, an event may be related to a constant reading in a sensor for a pre-defined time period in the facility 200. In some examples embodiments, an event may be a related to a mismatch in an operating condition with an operational status of a heating valve in the facility 200. In some example embodiments, an event may be a related to a deviation in a supply temperature of water with respect to a predefined threshold in the facility 200. In some example embodiments, an event may correspond to an overridden fan speed at a variable frequency drive (VFD) panel in the facility 200. In some example embodiments, an event may correspond to a wiring fault in command and feedback cables and/or controller terminals in the facility 200. In some example embodiments, an event may correspond to a mismatch in operational set points with respect to baseline set points of a heating-ventilation, and air-conditioning (HVAC) system in the facility 200.

In some example embodiments, the edge controller 204 and/or the cloud 106 can generate one or more recommendations to address the one or more events in the facility 200. In some example embodiments, the one or more recommendations may correspond to one or more service cases to address the one or more events in the facility 200. In some example embodiments, a service case may comprise instructions to check for a fault in a sensor in the facility 200. In some examples embodiments, a service case may comprise instructions to check an operating condition and an operational status of a heating valve in the facility 200. In some example embodiments, a service case may comprise instructions to check for deviation in a supply temperature of water with respect to a predefined threshold in the facility 200. In some example embodiments, a service case may comprise instructions to check the fan speed at the VFD panel in the facility 200. In some example embodiments, a service case may comprise instructions to correct the wiring in the command and feedback cables and/or controller terminals in the facility 200. In some example embodiments, a service case may comprise instructions to set operational set points of the HVAC system in the facility 200.

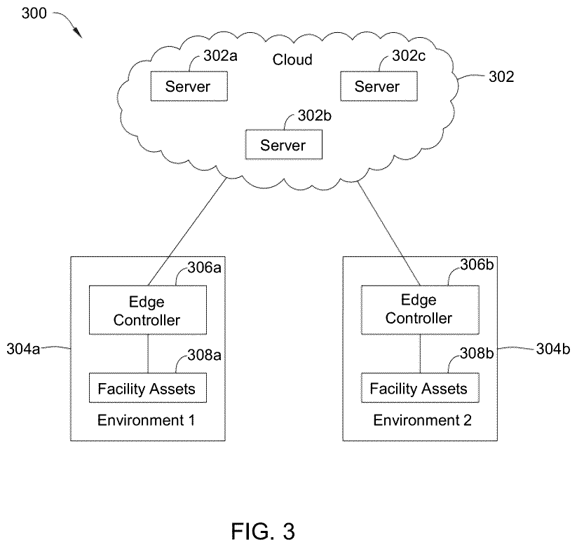

FIG. 3 illustrates a schematic diagram showing a facility management system to manage multiple facility sites. The facility management system 300 may use processing resources such as edge controllers (306a and 306b) in facilities (304a and 304b) to manage and configure one or more assets in the facilities (304a and 304b). In some example embodiments, the facility management system 300 may use processing resources such as the edge controllers (306a and 306b) at facilities (304a and 304b) to manage and configure one or more processes in the facilities (304a and 304b). In an example embodiment, facilities (304a and 304b) can include respective facility assets (308a and 308b) and edge controllers (306a and 306b). In an example embodiment, facility assets (308a and 308b) and/or edge controllers (306a and 306b) may be deployed in respective environment 1 and environment 2 of the facilities (304a and 304b). In some example embodiments, environment 1 and environment 2 may be similar. In some example embodiments, environment 1 and environment 2 may be different. In some example embodiments, the facility management system 300 may be configured to receive telemetry data associated with the facility assets (308a and 308b) and edge controllers (306a and 306b) from the facilities (304a and 304b).

In some example embodiments, the facility management system 300 may be configured to process the telemetry data associated with the facility assets (308a and 308b) and edge controllers (306a and 306b). In an example embodiment, the facility management system 300 may identify one or more events in the facilities (304a and 304b) based on processing of the telemetry data. In some example embodiments, the one or more events may be associated with the facility assets (308a and 308b). In some example embodiments, the one or more events may be associated with one or more processes in the facilities (304a and 304b). In some example embodiments, an event may be related to a constant reading in a sensor for a pre-defined time period in the facilities (304a and 304b). In some examples embodiments, an event may be a related to a mismatch in an operating condition with an operational status of a heating valve in the facilities (304a and 304b). In some example embodiments, an event may be a related to a deviation in a supply temperature of water with respect to a predefined threshold in the facilities (304a and 304b). In some example embodiments, an event may correspond to an overridden fan speed at a variable frequency drive (VFD) panel in the facilities (304a and 304b). In some example embodiments, an event may correspond to a wiring fault in command and feedback cables and/or controller terminals in the facilities (304a and 304b). In some example embodiments, an event may correspond to a mismatch in operational set points with respect to baseline set points of a heating-ventilation, and air-conditioning (HVAC) system in the facilities (304a and 304b).

In some example embodiments, the facility management system 300 may be configured to detect one or more root causes associated with one or more events. In some example embodiments, the facility management system 300 may be configured to detect one or more root causes based at least in part on one or more pre-defined rules in the cloud 302 and/or the edge controllers (306a and 306b). In some example embodiments, the facility management system 300 may be configured to generate one or more recommendations for the facilities (304a and 304b). In some example embodiments, the one or more recommendations may be generated in response to detection of the one or more root causes. In some example embodiments, the one or more recommendations may be generated based on the environment 1 and environment 2 of the facilities (304a and 304b). In this regard, in some example embodiments, a first recommendation generated for first environment (for example environment 1) may be related to a second recommendation generated for second environment (for example environment 2). In some other example embodiments, a first recommendation generated for first environment (for example environment 1) may be different than a second recommendation generated for second environment (for example environment 2). In some example embodiments, the one or more recommendations may be generated based on historic data. In some example embodiments, the historic data may comprise details of steps taken by personnel to resolve one or more heuristic root causes in the facilities (304a and 304b). In some example embodiments, the historic data may comprise one or more heuristic resolution codes for one or more past events in the facilities (304a and 304b).

In an example embodiment, the facility management system 300 can provide one or more recommendations to address the one or more root causes and resolve the one or more events in the facilities (304a and 304b). In some example embodiments, the one or more recommendations may correspond to one or more service cases. For instance, in some example embodiments, a service case may comprise instructions to check for a fault in a sensor in the facilities (304a and 304b). In some examples embodiments, a service case may comprise instructions to check an operating condition and an operational status of a heating valve in the facilities (304a and 304b). In some example embodiments, a service case may comprise instructions to check for deviation in a supply temperature of water with respect to a predefined threshold in the facilities (304a and 304b). In some example embodiments, a service case may comprise instructions to check the fan speed at the VFD panel in the facilities (304a and 304b). In some example embodiments, a service case may comprise instructions to correct the wiring in the command and feedback cables and/or controller terminals in the facilities (304a and 304b). In some example embodiments, a service case may comprise instructions to set operational set points of the HVAC system in the facilities (304a and 304b).

Further, in some example embodiments, the facility management system 300 can correlate the one or more recommendations generated for the facilities (304a and 304b). For instance, in some example embodiments, a first recommendation generated for a first facility (for example facility 304a) may be related to a second recommendation generated for a second facility (for example facility 304b). In some example embodiments, the first recommendation may be related to the second recommendation. In some example embodiments, relation between the first recommendation and the second recommendation is determined based on at least one of a type of asset, details of a personnel, and a type of environment of the facility. For instance, in some example embodiments, the facility assets (308a and 308b) of the facilities (304a and 304b) may be of same type i.e., a HVAC system, a AHU, a boiler, a sensor, a heating valve, and/or the like. In this regard, in some example embodiments, if a first recommendation for a HVAC system in the first facility is generated, then a second recommendation similar to that of the first recommendation may be generated for a HVAC system in the second facility. Further, in some example embodiments, the facility management system 300 can predict one or more events in the facilities (304a and 304b) based on correlation of the one or more recommendations. In this regard, in some example embodiments, a first recommendation related to a fault in an asset of the first facility may be utilized by the facility management system 300 to predict a fault in another asset of the second facility.

Further, in some example embodiments, the facility management system 300 may transmit one or more notifications to a device associated with a personnel. In some example embodiments, a notification may correspond to a prompt for a personnel to review the one or more recommendations. In some example embodiments, a notification may correspond to a prompt for a personnel to execute one or more instructions of a recommendation. In this regard, the prompt may be an audio or a visual one. In some example embodiments, the prompt may also indicate a priority of the recommendation.

The cloud 302 is illustrated as including a server 302a, a server 302b and a server 302c. In some example embodiments, the cloud 302 may only include one or two servers, or may include four, five or more distinct servers. In some example embodiments, the cloud 302 may provide distributed computing services, in which tasks can be moved from server to server as appropriate to balance workloads on each of the servers. In this way, if a particular server, say server 302a becomes heavily loaded while other servers such as the server 302b and/or the server 302c have available processing power and/or available memory space, some of the tasks currently being performed by the server 302a may be moved over to the server 302b and/or the server 302c so that the other server(s) can assist the server 302a with its current heavy workload. It will be appreciated that the relative workloads on each of the servers 302a, 302b, 302c may vary over time, such that while server 302a may be heavily loaded at a particular point in time, at other particular points in time it may be the server 302b and/or the server 302c that is heavily loaded. In one or more example embodiments, the cloud 302 may be configured to receive and/or transmit the one or more recommendations from and/or to the facilities (304a and 304b). In some exemplary embodiments, the cloud 302 may be configured to provide the one or more recommendations to the facilities (304a and 304b) to manage and configure one or more assets and/or processes in the facilities (304a and 304b).

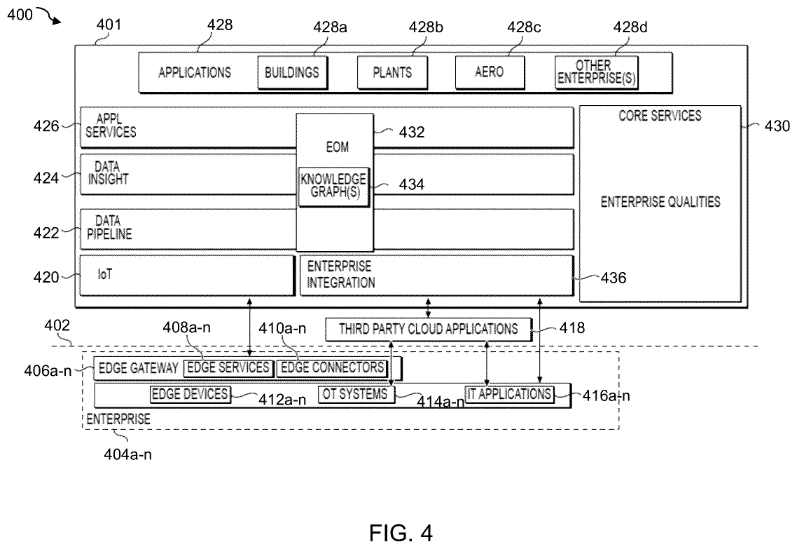

FIG. 4 illustrates a schematic block diagram of framework 400 of an IoT platform 401, according to the present disclosure. The IoT platform 401 of the present disclosure is a platform for facility management that uses real-time accurate models and/or visual analytics to deliver intelligent actionable recommendations for sustained peak performance of a facility or an enterprise 404a-404n. The IoT platform 401 is an extensible platform that is portable for deployment in any cloud or data center environment for providing an enterprise-wide, top to bottom view, displaying the status of processes, assets, people, and safety. Further, the IoT platform 401 supports end-to-end capability to execute digital twins against process data and to translate the output into actionable insights and/or intelligent recommendations, using the framework 400, detailed further below.

As shown in FIG. 4, the framework 400 of the IoT platform 401 comprises a number of layers including, for example, an IoT layer 420, an enterprise integration layer 436, a data pipeline layer 422, a data insight layer 424, an application services layer 426, and an applications layer 428. The IoT platform 401 also includes a core services layer 430 and an extensible object model (EOM) 432 comprising one or more knowledge graphs 434. The layers 420-430 further include various software components that together form each layer 420-430. For example, in one or more embodiments, each layer 420-430 includes one or more of the modules, models, engines, databases, services, applications, or combinations thereof. In some embodiments, the layers 420-430 are combined to form fewer layers. In some embodiments, some of the layers 420-430 are separated into separate, more numerous layers. In some embodiments, some of the layers 420-430 are removed while others may be added.

The IoT platform 401 is a model-driven architecture. Thus, in certain embodiments, the extensible object model (EOM) 432 communicates with each layer 420-430 to contextualize site data of the enterprise 404a-404n using an extensible object model (or “asset model”) and knowledge graphs 434 where the one or more assets (e.g., edge devices 412a-412n) and processes of the facility or the enterprise 404a-404n are modeled. In an example embodiment, the edge devices 412a-412n may be one of the one or more assets as illustrated in FIGS. 1-3. The knowledge graphs 434 of EOM 432 are configured to store the models in a central location. The knowledge graphs 434 define a collection of nodes and links that describe real-world connections that enable smart systems. As used herein, a knowledge graph 434: (i) describes real-world entities (e.g., edge devices 412a-412n) and their interrelations organized in a graphical interface; (ii) defines possible classes and relations of entities in a schema; (iii) enables interrelating arbitrary entities with each other; and (iv) covers various topical domains. In other words, the knowledge graphs 434 define large networks of entities (e.g., edge devices 412a-412n), semantic types of the entities, properties of the entities, and relationships between the entities. Thus, the knowledge graphs 434 describe a network of “things” that are relevant to a specific domain, an enterprise, or a facility. Knowledge graphs 434 are not limited to abstract concepts and relations, but can also contain instances of objects, such as, for example, documents and datasets. In some example embodiments, the knowledge graphs 434 include resource description framework (RDF) graphs. As used herein, a “RDF graph” is a graph data model that formally describes the semantics, or meaning, of information. The RDF graph also represents metadata (e.g., data that describes data). In some example embodiments, the knowledge graphs 434 may comprise relation between one or more recommendations as described in exemplary embodiments associated with FIGS. 1-3. In some example embodiments, the relation between the one or more recommendations may be represented in the knowledge graphs 434 using at least one of: one or more service cases, one or more events, one or more root causes, and/or one or more resolution codes. In some example embodiments, the knowledge graphs 434 can be related to the one or more service cases in the facility or the enterprise. In some example embodiments, the knowledge graphs 434 may comprise a relationship between the one or more events. In some example embodiments, the knowledge graphs 434 may comprise information of one or more root causes associated with the one or more events. In some example embodiments, the knowledge graphs 434 may comprise information of one or more resolution codes associated with the one or more events. In some example embodiments, the one or more resolution codes may correspond to a category associated with the one or more root causes. In some example embodiments, the one or more resolution codes may correspond to a type of action undertaken by a personnel in the facility. In some example embodiments, the knowledge graphs 434 may comprise a set of tags related to the one or more recommendations. According to various example embodiments, the knowledge graphs 434 also include a semantic object model. The semantic object model is a subset of a knowledge graph 434 that defines semantics for the knowledge graph 434. For example, the semantic object model defines the schema for the knowledge graph 434.

As used herein, EOM 432 is a collection of application programming interfaces (APIs) that enables seeded semantic object models to be extended. For example, the EOM 432 of the present disclosure enables a customer's knowledge graph 434 to be built subject to constraints expressed in the customer's semantic object model. Thus, the knowledge graphs 434 are generated by customers (e.g., enterprises or organizations) to create models of the edge devices 412a-412n of an enterprise 404a-404n, and the knowledge graphs 434 are input into the EOM 432 for visualizing the models (e.g., the nodes and links).

The models describe the assets (e.g., the nodes) of an enterprise (e.g., the edge devices 412a-412n) and describe the relationship of the assets with other components (e.g., the links). The models also describe the schema (e.g., describe what the data is), and therefore the models are self-validating. For example, in one or more embodiments, the model describes the type of sensors mounted on any given asset (e.g., edge device 412a-412n) and the type of data that is being sensed by each sensor. According to various embodiments, a key performance indicator (KPI) framework is used to bind properties of the assets in the extensible object model 432 to inputs of the KPI framework. Accordingly, the IoT platform 401 is an extensible, model-driven end-to-end stack including: two-way model sync and secure data exchange between the edge and the cloud, metadata driven data processing (e.g., rules, calculations, and aggregations), and model driven visualizations and applications. As used herein, “extensible” refers to the ability to extend a data model to include new service cases, new rules, new root causes, new resolution codes, new tags, new properties, new columns, new fields, new classes, new tables, and new relations. In some example embodiments, when a user or a worker works on a service case to address an event, the user or the worker can provide a feedback on one or more recommendations. In some example embodiments, the feedback can be provided as tagged information. In this regard, in some example embodiments, the tagged information may comprise information preceded with a hashtag. In some example embodiments, the tagged information may comprise, but not limited to new service cases, new rules, new root causes, new resolution codes, new tags, new properties, new columns, new fields, new classes, new tables, and new relations. In some example embodiments, the knowledge graphs 434 may be updated based on the tagged information. Thus, the IoT platform 401 is extensible with regards to edge devices 412a-412n and the applications that handle those devices 412a-412n. For example, when new edge devices 412a-412n are added to an enterprise 404a-404n system, the new devices 412a-412n will automatically appear in the IoT platform 401 so that the corresponding applications 428 understand and use the data from the new devices 412a-412n to manage the new devices and/or processes in the facility or the enterprise 404a-404n.

In some cases, asset templates are used to facilitate configuration of instances of edge devices 412a-412n in the model using common structures. An asset template defines the typical properties for the edge devices 412a-412n of a given facility or enterprise 404a-404n for a certain type of device or asset. For example, an asset template of a pump includes modeling the pump having inlet and outlet pressures, speed, flow, etc. The templates may also include hierarchical or derived types of edge devices 412a-412n to accommodate variations of a base type of device 161a-161n. For example, a reciprocating pump is a specialization of a base pump type and would include additional properties in the template. Instances of the edge device 412a-412n in the model are configured to match the actual, physical devices of the enterprise 404a-404n using the templates to define expected attributes of the device 412a-412n. Each attribute is configured either as a static value (e.g., capacity is 1000 BPH) or with a reference to a time series tag that provides the value. The knowledge graph 434 can automatically map the tag to the attribute based on naming conventions, parsing, and matching the tag and attribute descriptions and/or by comparing the behavior of the time series data with expected behavior. In some example embodiments, the knowledge graph 434 is configured to utilize the asset template to determine the one or more service cases to address the one or more events in the enterprise 404a-404n.

In certain example embodiments, the modeling phase includes an onboarding process for syncing the models between the edge and the cloud. For example, in one or more example embodiments, the onboarding process includes a simple onboarding process, a complex onboarding process, and/or a standardized rollout process. The simple onboarding process includes the knowledge graph 434 receiving raw model data from the edge and running context discovery algorithms to generate the model. The context discovery algorithms read the context of the edge naming conventions of the edge devices 412a-412n and determine what the naming conventions refer to. For example, in one or more example embodiments, the knowledge graph 434 receives “TMP” during the modeling phase and determine that “TMP” relates to “temperature.” The generated models are then published. In certain example embodiments, the complex onboarding process includes the knowledge graph 434 receiving the raw model data, receiving point history data, and receiving site survey data. According to various example embodiments, the knowledge graph 434 then uses these inputs to run the context discovery algorithms. According to various example embodiments, the generated models are edited and then the models are published. The standardized rollout process includes manually defining standard models in the cloud and pushing the models to the edge. In some example embodiments, the modeling phase can also include construction of the knowledge graph 434 using the tagged information related to the one or more recommendations.

The IoT layer 420 includes one or more components for device management, data ingest, and/or command/control of the edge devices 412a-412n. The components of the IoT layer 420 enable data to be ingested into, or otherwise received at, the IoT platform 401 from a variety of sources. For example, in one or more example embodiments, data is ingested from the edge devices 412a-412n through process historians or laboratory information management systems. The IoT layer 420 is in communication with the edge connectors 410a-410n installed on the edge gateways 406a-406n through network 402, and the edge connectors 410a-410n send the data securely to the IoT platform 401. In some example embodiments, only authorized data is sent to the IoT platform 401, and the IoT platform 401 only accepts data from authorized edge gateways 406a-406n and/or edge devices 412a-412n. According to various example embodiments, data is sent from the edge gateways 406a-406n to the IoT platform 401 via direct streaming and/or via batch delivery. Further, after any network or system outage, data transfer will resume once communication is re-established and any data missed during the outage will be backfilled from the source system or from a cache of the IoT platform 401. According to various example embodiments, the IoT layer 420 also includes components for accessing time series, alarms and events, and transactional data via a variety of protocols.

The enterprise integration layer 436 includes one or more components for events/messaging, file upload, and/or REST/OData. The components of the enterprise integration layer 436 enable the IoT platform 401 to communicate with third party cloud applications 418, such as any application(s) operated by an enterprise in relation to its edge devices. For example, the enterprise integration layer 436 connects with enterprise databases, such as guest databases, customer databases, financial databases, patient databases, etc. The enterprise integration layer 436 provides a standard application programming interface (API) to third parties for accessing the IoT platform 401. The enterprise integration layer 436 also enables the IoT platform 401 to communicate with the OT systems 414a-414n and IT applications 416a-416n of the enterprise 404a-404n. Thus, the enterprise integration layer 436 enables the IoT platform 401 to receive data from the third-party applications 418 rather than, or in combination with, receiving the data from the edge devices 412a-412n directly. In some example embodiments, the enterprise integration layer 436 also enables the IoT platform 401 to receive a feedback from one or more users related to the one or more recommendations.

The data pipeline layer 422 includes one or more components for data cleansing/enriching, data transformation, data calculations/aggregations, and/or API for data streams. Accordingly, in one or more example embodiments, the data pipeline layer 422 pre-processes and/or performs initial analytics on the received data. The data pipeline layer 422 executes advanced data cleansing routines including, for example, data correction, mass balance reconciliation, data conditioning, component balancing and simulation to ensure the desired information is used as a basis for further processing. The data pipeline layer 422 also provides advanced and fast computation capabilities. In some example embodiments, the data pipeline layer 422 can process the feedback to identify new service cases, new rules, new root causes, new resolution codes, new tags, new properties, new columns, new fields, new classes, new tables, and new relations, etc. For example, in one or more example embodiments, cleansed data is run through enterprise-specific digital twins. According to various example embodiments, the enterprise-specific digital twins include a reliability advisor containing process models to determine the current operation and the fault models to trigger any early detection and determine an appropriate resolution. According to various example embodiments, the digital twins also include an optimization advisor that integrates real-time economic data with real-time process data, selects the right feed for a process, and determines optimal process conditions and product yields.

According to various example embodiments, the data pipeline layer 422 employs models and templates to define calculations and analytics. Additionally or alternatively, according to various example embodiments, the data pipeline layer 422 employs models and templates to define how the calculations and analytics relate to the one or more assets (e.g., the edge devices 412a-412n). In some example embodiments, the data pipeline layer 422 can identify one or more events in the enterprise 404a-404n. For example, in an example embodiment, a fan template defines fan efficiency calculations such that every time a fan is configured, the standard efficiency calculation is automatically executed for the fan. The calculation model defines the various types of calculations, the type of engine that should run the calculations, the input and output parameters, the preprocessing requirement and prerequisites, the schedule, etc. According to various example embodiments, the actual calculation or analytic logic is defined in the template or it may be referenced. Thus, according to various example embodiments, the calculation model is employed to describe and control the execution of a variety of different process models. According to various example embodiments, calculation templates are linked with the asset templates such that when an asset (e.g., edge device 412a-412n) instance is created, any associated calculation instances are also created with their input and output parameters linked to the appropriate attributes of the asset (e.g., edge device 412a-412n). According to various example embodiments, the data pipeline layer 422 can identify one or more service cases to address the one or more events in the enterprise 404a-404n.

According to various example embodiments, the IoT platform 401 supports a variety of different analytics models including, for example, curve fitting models, regression analysis models, first principles models, empirical models, engineered models, user-defined models, machine learning models, built-in functions, and/or any other types of analytics models. Fault models and predictive maintenance models will now be described by way of example, but any type of models may be applicable.

Fault models are used to compare current and predicted enterprise 404a-404n performance to identify issues or opportunities, and the potential causes or drivers of the issues or opportunities. The IoT platform 401 includes rich hierarchical symptom-fault models to identify abnormal conditions and their potential consequences. For example, in one or more embodiments, the IoT platform 401 drill downs from a high-level condition to understand the contributing factors, as well as determining the potential impact a lower level condition may have. There may be multiple fault models for a given enterprise 404a-404n looking at different aspects such as process, equipment, control, and/or operations. According to various example embodiments, each fault model identifies issues and opportunities in their domain, and can also look at the same core problem from a different perspective. According to various example embodiments, an overall fault model is layered on top to synthesize the different perspectives from each fault model into an overall assessment of the situation and point to the true root cause.

According to various example embodiments, when a fault or opportunity is identified, the IoT platform 401 provides one or more action based recommendations about optimal corrective actions to take. Initially, the recommendations are based on expert knowledge that has been pre-programmed into the system by process and equipment experts. A recommendation services module presents this information in a consistent way regardless of source, and supports workflows to track, close out, and document the recommendation follow-up. According to various example embodiments, the recommendation follow-up is employed to improve the overall knowledge of the system over time as existing recommendations are validated (or not) or new cause and effect relationships are learned by users and/or analytics.

According to various example embodiments, the models are used to accurately predict what will occur before it occurs and interpret the status of the installed base. Thus, the IoT platform 401 enables operators to quickly initiate maintenance measures when irregularities occur. In some example embodiments, the one or more recommendations can be created to address the irregularities in the enterprise 404a-404n. According to various example embodiments, the digital twin architecture of the IoT platform 401 employs a variety of modeling techniques. According to various example embodiments, the modeling techniques include, for example, rigorous models, fault detection and diagnostics (FDD), descriptive models, predictive maintenance, prescriptive maintenance, process optimization, and/or any other modeling technique.

According to various example embodiments, the rigorous models are converted from process design simulation. In this manner, in certain example embodiments, process design is integrated with feed conditions. Process changes and technology improvement provide business opportunities that enable more effective maintenance schedule and deployment of resources in the context of production needs. The fault detection and diagnostics include generalized rule sets that are specified based on industry experience and domain knowledge and can be easily incorporated and used working together with equipment models. According to various example embodiments, the descriptive models identifies a problem and the predictive models determines possible damage levels and maintenance options. According to various example embodiments, the descriptive models include models for defining the operating windows for the edge devices 412a-412n.

Predictive maintenance includes predictive analytics models developed based on rigorous models and statistic models, such as, for example, principal component analysis (PCA) and partial least square (PLS). According to various example embodiments, machine learning methods are applied to train models for fault prediction. According to various example embodiments, predictive maintenance leverages FDD-based algorithms to continuously monitor individual control and equipment performance. Predictive modeling is then applied to a selected condition indicator that deteriorates in time. Prescriptive maintenance includes determining an optimal maintenance option and when it should be performed based on actual conditions rather than time-based maintenance schedule. According to various example embodiments, prescriptive analysis selects the right solution based on the company's capital, operational, and/or other requirements. Process optimization is determining optimal conditions via adjusting set-points and schedules. The optimized set-points and schedules can be communicated directly to the underlying controllers, which enables automated closing of the loop from analytics to control.

The data insight layer 424 includes one or more components for time series databases (TDSB), relational/document databases, data lakes, blob, files, images, and videos, and/or an API for data query. According to various example embodiments, when raw data is received at the IoT platform 401, the raw data is stored as time series tags or events in warm storage (e.g., in a TSDB) to support interactive queries and to cold storage for archive purposes. According to various example embodiments, the raw data may comprise tagged information provided by a user or a worker via a user interface. According to various example embodiments, data is sent to the data lakes for offline analytics development. According to various example embodiments, the data pipeline layer 422 accesses the data stored in the databases of the data insight layer 424 to perform analytics, as detailed above.

The application services layer 426 includes one or more components for rules engines, workflow/notifications, KPI framework, insights (e.g., actionable insights), decisions, recommendations, machine learning, and/or an API for application services. The application services layer 426 enables building of applications 428a-d. The applications layer 428 includes one or more applications 428a-d of the IoT platform 401. For example, according to various example embodiments, the applications 428a-d includes a buildings application 428a, a plants application 428b, an aero application 428c, and other enterprise applications 428d. According to various example embodiments, the applications 428 includes general applications for portfolio management, asset management, autonomous control, and/or any other custom applications. According to various example embodiments, portfolio management includes the KPI framework and a flexible user interface (UI) builder. According to various example embodiments, asset management includes asset performance, asset health, and/or asset predictive maintenance. According to various example embodiments, autonomous control includes energy optimization and/or predictive maintenance. As detailed above, according to various example embodiments, the general applications 428a-d is extensible such that each application 428a-d is configurable for the different types of enterprises 404a-404n (e.g., buildings application 428a, plants application 428b, aero application 428c, and other enterprise applications 428d).

The applications layer 428 also enables visualization of performance of the enterprise 404a-404n. For example, dashboards provide a high-level overview with drill downs to support deeper investigations. In one or more example embodiments, the dashboards provide one or more service cases to address the one or more events in the enterprise 404a-404n. Recommendation summaries give users prioritized actions to address current or potential issues and opportunities. Data analysis tools support ad hoc data exploration to assist in troubleshooting and process improvement. In one or more example embodiments, the dashboards may represent a ranking of one or more users or worker.

The core services layer 430 includes one or more services of the IoT platform 401. According to various example embodiments, the core services 430 include data visualization, data analytics tools, security, scaling, and monitoring. According to various example embodiments, the core services 430 also include services for tenant provisioning, single login/common portal, self-service admin, UI library/UI tiles, identity/access/entitlements, logging/monitoring, usage metering, API gateway/dev portal, and the IoT platform 401 streams.

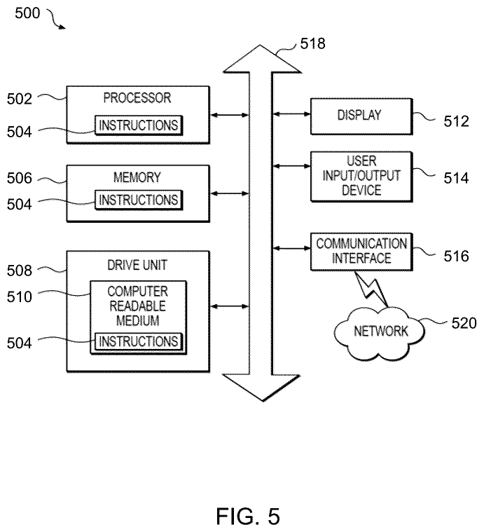

FIG. 5 depicts an implementation of a controller 500 that may execute techniques presented herein, according to one or more example embodiments. The controller 500 may include a set of instructions that can be executed to cause the controller 500 to perform any one or more of the methods or computer based functions disclosed herein. The controller 500 may operate as a standalone device or may be connected, e.g., using a network, to other computer systems or peripheral devices.

In a networked deployment, the controller 500 may operate in the capacity of a server or as a client in a server-client user network environment, or as a peer computer system in a peer-to-peer (or distributed) network environment. The controller 500 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular implementation, the controller 500 can be implemented using electronic devices that provide voice, video, or data communication. Further, while the controller 500 is illustrated as a single system, the term “system” shall also be taken to include any collection of systems or sub-systems that individually or jointly execute a set, or multiple sets, of instructions to perform one or more computer functions.

As illustrated in FIG. 5, the controller 500 may include a processor 502, e.g., a central processing unit (CPU), a graphics processing unit (GPU), or both. The processor 502 may be a component in a variety of systems. For example, the processor 502 may be part of a standard computer. The processor 502 may be one or more general processors, digital signal processors, application specific integrated circuits, field programmable gate arrays, servers, networks, digital circuits, analog circuits, combinations thereof, or other now known or later developed devices for analyzing and processing data. The processor 502 may implement a software program, such as code generated manually (i.e., programmed).

The controller 500 may include a memory 506 that can communicate via a bus 518. The memory 506 may be a main memory, a static memory, or a dynamic memory. The memory 506 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 506 includes a cache or random-access memory for the processor 502. In alternative implementations, the memory 506 is separate from the processor 502, such as a cache memory of a processor, the system memory, or other memory. The memory 506 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 506 is operable to store instructions executable by the processor 502. The functions, acts or tasks illustrated in the figures or described herein may be performed by the processor 502 executing the instructions stored in the memory 506. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the controller 500 may further include a display 512, such as a liquid crystal display (LCD), an organic light emitting diode (OLED), a flat panel display, a solid-state display, a cathode ray tube (CRT), a projector, a printer or other now known or later developed display device for outputting determined information. The display 512 may act as an interface for the user to see the functioning of the processor 502, or specifically as an interface with the software stored in the memory 506 or in the drive unit 508.

Additionally or alternatively, the controller 500 may include an input/output device 514 configured to allow a user to interact with any of the components of controller 500. The input/output device 514 may be a number pad, a keyboard, or a cursor control device, such as a mouse, or a joystick, touch screen display, remote control, or any other device operative to interact with the controller 500.

The controller 500 may also or alternatively include drive unit 508 implemented as a disk or optical drive. The drive unit 508 may include a computer-readable medium 510 in which one or more sets of instructions 504, e.g. software, can be embedded. Further, the instructions 504 may embody one or more of the methods or logic as described herein. The instructions 504 may reside completely or partially within the memory 506 and/or within the processor 502 during execution by the controller 500. The memory 506 and the processor 502 also may include computer-readable media as discussed above.

In some systems, a computer-readable medium 510 includes instructions 504 or receives and executes instructions 504 responsive to a propagated signal so that a device connected to a network 520 can communicate voice, video, audio, images, or any other data over the network 520. Further, the instructions 504 may be transmitted or received over the network 520 via a communication port or interface 516, and/or using a bus 518. The communication port or interface 516 may be a part of the processor 502 or may be a separate component. The communication port or interface 516 may be created in software or may be a physical connection in hardware. The communication port or interface 516 may be configured to connect with a network 520, external media, the display 512, or any other components in controller 500, or combinations thereof. The connection with the network 520 may be a physical connection, such as a wired Ethernet connection or may be established wirelessly as discussed below. Likewise, the additional connections with other components of the controller 500 may be physical connections or may be established wirelessly. The network 520 may alternatively be directly connected to a bus 518.

While the computer-readable medium 510 is shown to be a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding, or carrying a set of instructions for execution by a processor or that cause a computer system to perform any one or more of the methods or operations disclosed herein. The computer-readable medium 510 may be non-transitory, and may be tangible.

The computer-readable medium 510 can include a solid-state memory such as a memory card or other package that houses one or more non-volatile read-only memories. The computer-readable medium 510 can be a random-access memory or other volatile re-writable memory. Additionally or alternatively, the computer-readable medium 510 can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative implementation, dedicated hardware implementations, such as application specific integrated circuits, programmable logic arrays and other hardware devices, can be constructed to implement one or more of the methods described herein. Applications that may include the apparatus and systems of various implementations can broadly include a variety of electronic and computer systems. One or more implementations described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The controller 500 may be connected to a network 520. The network 520 may define one or more networks including wired or wireless networks. The wireless network may be a cellular telephone network, an 802.11, 802.16, 802.20, or WiMAX network. Further, such networks may include a public network, such as the Internet, a private network, such as an intranet, or combinations thereof, and may utilize a variety of networking protocols now available or later developed including, but not limited to TCP/IP based networking protocols. The network 520 may include wide area networks (WAN), such as the Internet, local area networks (LAN), campus area networks, metropolitan area networks, a direct connection such as through a Universal Serial Bus (USB) port, or any other networks that may allow for data communication. The network 520 may be configured to couple one computing device to another computing device to enable communication of data between the devices. The network 520 may generally be enabled to employ any form of machine-readable media for communicating information from one device to another. The network 520 may include communication methods by which information may travel between computing devices. The network 520 may be divided into sub-networks. The sub-networks may allow access to all of the other components connected thereto or the sub-networks may restrict access between the components. The network 520 may be regarded as a public or private network connection and may include, for example, a virtual private network or an encryption or other security mechanism employed over the public Internet, or the like.

In accordance with various implementations of the present disclosure, the methods described herein may be implemented by software programs executable by a computer system. Further, in an exemplary, non-limited implementation, implementations can include distributed processing, component/object distributed processing, and parallel processing. Alternatively, virtual computer system processing can be constructed to implement one or more of the methods or functionality as described herein.

Although the present specification describes components and functions that may be implemented in particular implementations with reference to particular standards and protocols, the disclosure is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

It will be understood that the steps of methods discussed are performed in one embodiment by an appropriate processor (or processors) of a processing (i.e., computer) system executing instructions (computer-readable code) stored in storage. It will also be understood that the disclosure is not limited to any particular implementation or programming technique and that the disclosure may be implemented using any appropriate techniques for implementing the functionality described herein. The disclosure is not limited to any particular programming language or operating system.

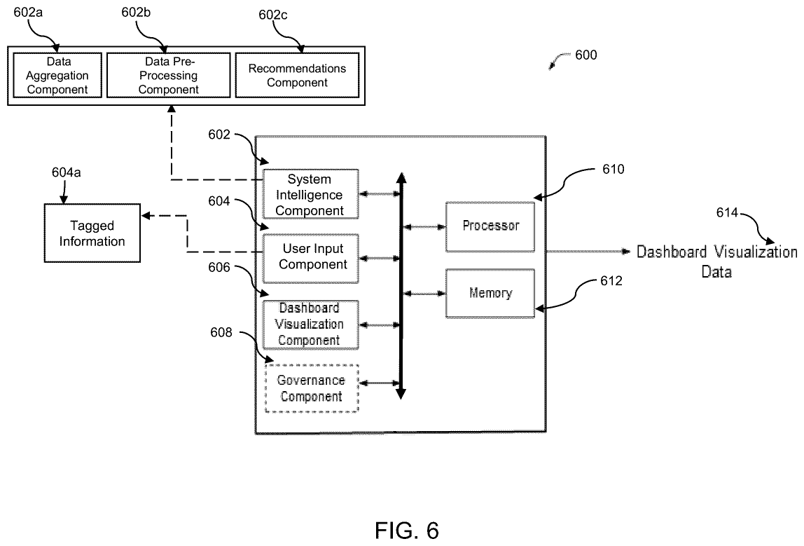

FIG. 6 illustrates a schematic diagram showing an implementation of a service case management system 600 of a facility management system. In some example embodiments, the service case management system 600 can be used for management of service cases in a facility. In this regard, a service case can correspond to a work task, a work ticket raised to resolve an issue, an action item etc. which can be tracked at various stages of its execution for resolution of an issue in the facility. In some examples, the issue may correspond to a maintenance operation, a fault inspection, a device management issue, remote configuration etc. associated with an asset (e.g. HVAC unit, lighting system, air purification system, etc.) of a facility. In some examples, the service case management system 600 can receive data from various data sources. For instance, the service case management system 600 can receive data, for example, but not limited to, (a) telemetry data from assets, (b) historical service case management data, (c) real-time input feed from a field technician, (d) system configuration data, etc. The service case management system 600 can process the data received from various data sources and construct a data model. The data model can be trained and utilized for predicting service case requirement, management of assets, generating insights and recommendations to resolve the service cases.

In some example embodiments, the service case management system 600 may be configured to receive telemetry data associated with facilities 102. In some example embodiments, the system 600 is configured to analyze telemetry data to detect one or more events in one or more facilities. In this regard, the system 600 may facilitate a practical application of identification of one or more events by pattern recognition in the telemetry data. According to some example embodiments, the system 600 facilitates a practical application of data analytics technology and/or digital transformation technology to provide one or more recommendations for the one or more events.

In an example embodiment, the service case management system 600 is a server system (e.g., a server device) that facilitates a data analytics platform between one or more computing devices, one or more data sources, and/or one or more assets. In one or more example embodiments, the service case management system 600 is a device with one or more processors and a memory. For example, in one or more example embodiments, the service case management system 600 is implemented via the cloud 106. The service case management system 600 is also related to one or more technologies, such as, for example, enterprise technologies, connected building technologies, industrial technologies, Internet of Things (IoT) technologies, data analytics technologies, digital transformation technologies, cloud computing technologies, cloud database technologies, server technologies, network technologies, private enterprise network technologies, wireless communication technologies, machine learning technologies, artificial intelligence technologies, digital processing technologies, electronic device technologies, computer technologies, supply chain analytics technologies, aircraft technologies, industrial technologies, cybersecurity technologies, navigation technologies, asset visualization technologies, oil and gas technologies, petrochemical technologies, refinery technologies, process plant technologies, procurement technologies, and/or one or more other technologies.

In some example embodiments, the service case management system 600 may comprise one or more components such as, a system intelligence component 602, a user input component 604, and/or a dashboard visualization component 606. Additionally, in one or more example embodiments, the service case management system 600 includes a processor 610 and/or a memory 612. Additionally, in some example embodiments, the service case management system 600 includes a governance component 608. In certain example embodiments, one or more aspects of the service case management system 600 (and/or other systems, apparatuses and/or processes disclosed herein) constitute executable instructions embodied within a computer-readable storage medium (e.g., the memory 612). For instance, in an example embodiment, the memory 612 stores computer executable component and/or executable instructions (e.g., program instructions). Furthermore, the processor 610 facilitates execution of the computer executable components and/or the executable instructions (e.g., the program instructions). In an example embodiment, the processor 610 is configured to execute instructions stored in memory 612 or otherwise accessible to the processor 610.

The processor 610 is a hardware entity (e.g., physically embodied in circuitry) capable of performing operations according to one or more embodiments of the disclosure. Alternatively, in an example embodiment where the processor 610 is embodied as an executor of software instructions, the software instructions configure the processor 610 to perform one or more algorithms and/or operations described herein in response to the software instructions being executed. In an example embodiment, the processor 610 is a single core processor, a multi-core processor, multiple processors internal to the service case management system 600, a remote processor (e.g., a processor implemented on a server), and/or a virtual machine. In certain example embodiments, the processor 610 is in communication with the memory 612, the user input component 604, the system intelligence component 602, the dashboard visualization component 606, and/or the governance component 608 via a bus to, for example, facilitate transmission of data among the processor 610, the memory 612, the user input component 604, the system intelligence component 602, the dashboard visualization component 606, and/or the governance component 608. In accordance with some example embodiments, the system intelligence component 602 may comprise data aggregation component 602a, data pre-processing component 602b, and recommendations component 602c. The processor 610 may be embodied in a number of different ways and, in certain example embodiments, includes one or more processing devices configured to perform independently. Additionally or alternatively, in one or more example embodiments, the processor 610 includes one or more processors configured in tandem via a bus to enable independent execution of instructions, pipelining of data, and/or multi-thread execution of instructions.

The memory 612 is non-transitory and includes, for example, one or more volatile memories and/or one or more non-volatile memories. In other words, in one or more example embodiments, the memory 612 is an electronic storage device (e.g., a computer-readable storage medium). The memory 612 is configured to store information, data, content, one or more applications, one or more instructions, or the like, to enable the service case management system 600 to carry out various functions in accordance with one or more embodiments disclosed herein. In accordance with some example embodiments described herein, the memory 612 may correspond to an internal or external memory of the service case management system 600. In some examples, the memory 612 may correspond to a database communicatively coupled to the service case management system 600. As used herein in this disclosure, the term “component,” “system,” and the like, is a computer-related entity. For instance, “a component,” “a system,” and the like disclosed herein is either hardware, software, or a combination of hardware and software. As an example, a component is, but is not limited to, a process executed on a processor, a processor circuitry, an executable component, a thread of instructions, a program, and/or a computer entity.

In one or more example embodiments, the system intelligence component 602 (e.g., recommendations component 602c) may be configured to generate one or more recommendations. In some example embodiments, the one or more recommendations may be one or more service cases. In some example embodiments, the one or more recommendations may also correspond to details in one or more service cases. In some example embodiments, the one or more recommendations may be one or more specific actions that a personnel has to undertake in the facility. According to some example embodiments, the system intelligence component 602 (e.g., recommendations component 602c) may be configured to generate a service case based on one or more historic recommendations. In some example embodiments, the one or more historic recommendations may comprise rule based recommendations generated by a rule engine.

According to some example embodiments, the dashboard visualization component 606 generates dashboard visualization data 614. In one or more example embodiments, the dashboard visualization data 614 comprises one or more service cases. For instance, in one or more example embodiments, the dashboard visualization component 606 provides the dashboard visualization data 614 to an electronic interface of a computing device (not shown). In one or more example embodiments, the dashboard visualization data 614 includes data associated with one or more service cases. In one or more example embodiments, the dashboard visualization component 606 allows a personnel to select one or more service cases to view details of the one or more service cases. In some example embodiments, the details may comprise one or more fields such as, but not limited to a root cause, a resolution code, and a resolution description. In some example embodiments, the resolution description may comprise one or more instructions to address the events in the facility.

In one or more example embodiments, the dashboard visualization component 606 generates dashboard visualization data 614 indicative of a ranking of the one or more service cases. In one or more example embodiments, the dashboard visualization component 606 generates dashboard visualization data 614 indicative of a ranking of one or more users. In an example embodiment, the dashboard visualization component 606 generates a user-interactive electronic interface that renders a visual representation of at least one service case. In another example embodiment, the dashboard visualization component 606 transmits to a computing device, one or more notifications associated with the at least one service case. In some example embodiments, the at least one service case may correspond to one or more recommendations related to facilities. In some example embodiments, a notification may correspond to a prompt for a personnel to review the one or more recommendations. In some example embodiments, a notification may correspond to a prompt for a personnel to execute one or more instructions of a recommendation. In this regard, the prompt may be an audio or a visual one. In some example embodiments, the prompt may also indicate a priority of the recommendation. In another example embodiment, the dashboard visualization component 606 allows users to modify one or more recommendations via the electronic interface. In certain example embodiments, the dashboard visualization data 614 can be indicative of a first notification that a resolution input is generated. In one or more example embodiments, the dashboard visualization data 614 can be indicative of a second notification that prompts one or more users to provide a feedback on the resolution input. In one or more example embodiments, the dashboard visualization data 614 can be indicative of an accuracy of the resolution input. In another example embodiments, the dashboard visualization data 614 is configured to present a digital twin visualization of one or more assets to provide individual control of the one or more assets via the dashboard visualization component 606.

According to some example embodiments, the service case management system 600 (e.g., the user input component 604 of the service case management system 600) receives one or more inputs from a user or a worker via a user interface of a computing device (not shown). In one or more example embodiments, the one or more inputs are associated with a portfolio of assets in the facility. For instance, in one or more example embodiments, the portfolio of assets may include one or more assets which may be, not limited to one or more building assets, one or more industrial assets, etc.), one or more IoT devices (e.g., one or more industrial IoT devices), one or more connected building assets, one or more sensors, one or more actuators, one or more processors, one or more computers, one or more valves, one or more pumps (e.g., one or more centrifugal pumps, etc.), one or more motors, one or more compressors, one or more turbines, one or more ducts, one or more heaters, one or more chillers, one or more coolers, one or more boilers, one or more furnaces, one or more heat exchangers, one or more fans, one or more blowers, one or more conveyor belts, one or more vehicle components, one or more cameras, one or more displays, one or more security components, one or more HVAC components, industrial equipment, factory equipment, and/or one or more other devices that are connected to the network 402 for collecting, sending, and/or receiving information. In one or more example embodiments, the one or more assets include, or is otherwise in communication with, one or more controllers for selectively controlling a respective asset and/or for sending/receiving information between the one or more assets and the service case management system 600 via the network 402. In one or more example embodiments, the one or more inputs can be provided by the user while resolving at least one service case rendered as a dashboard. In some example embodiments, the one or more inputs may correspond to a selection of a pre-defined option in the service case. In one or more example embodiments, the one or more inputs can be provided by the user as tagged information 604a. In some example embodiments, the tagged information 604a may be related to one or more recommendations in the service case. In some example embodiments, the tagged information 604a may comprise information preceded with a hashtag. In one or more example embodiments, the tagged information 604a can be indicative of a relevancy of the at least one service case for one or more assets. According to some example embodiments, the tagged information 604a may be a tagged resolution code. According to some example embodiments, the tagged information 604a may be a tagged root cause. According to some example embodiments, the tagged information 604a may be a tagged description. In one or more example embodiments, the tagged resolution code may be indicative of a new resolution code for the at least one service case. In one or more example embodiments, the tagged root cause may be indicative of a new root cause for the at least one service case. In one or more example embodiments, the tagged description may be indicative of a description of a new recommendation for the at least one service case. In this regard, in the exemplary embodiments described herein, the user may provide a new recommendation being tagged with #RecNew. In this regard, in the exemplary embodiments described herein, the user may provide the tagged information indicating a relevancy of at least one service case being tagged with #RecIn.

In some example embodiments, a service case may be generated based on historical data and/or past events. In some instances, these details may be irrelevant for addressing an event related to an asset. In such exemplary embodiments, the user may use their knowledge and perform one or more steps to address the events. According to some example embodiments, the user may provide a feedback on the details of the service case as tagged information 604a. In this regard, in some example embodiments, tagged information 604a may be indicative of irrelevancy of the service case. Further, in some example embodiments, the user may provide tagged information 604a indicative of a new recommendation relevant for the asset. Further, in some example embodiments, the user may provide tagged information 604a indicative of a new rule that is relevant for the asset. Further, in some example embodiments, the user may provide tagged information 604a indicative of additional information related to the service case. In some example embodiments, the additional information 604a can correspond to, but not limited to an additional recommendation, an additional rule, an additional resolution code, an additional root cause code for the service case. According to some example embodiments, the user may also provide the one or more steps that was undertaken to address the event as tagged information 604a.

In one or more example embodiments, the service case management system 600 (e.g., the user input component 604 of the service case management system 600) receives the one or more inputs via the network 402. In one or more example embodiments, the network 402 is a Wi-Fi network, a Near Field Communications (NFC) network, a Worldwide Interoperability for Microwave Access (WiMAX) network, a personal area network (PAN), a short-range wireless network (e.g., a Bluetooth® network), an infrared wireless (e.g., IrDA) network, an ultra-wideband (UWB) network, an induction wireless transmission network, and/or another type of network.

In one or more example embodiments, the system intelligence component 602 (e.g., data pre-processing component 602b) processes the one or more inputs received from the user for at least one service case. In one or more example embodiments, the system intelligence component 602 (e.g., data pre-processing component 602b) processes the tagged information. For instance, in one or more example embodiments, the system intelligence component 602 (e.g., data pre-processing component 602b) identifies one or more new recommendations based on processing of tagged information. For instance, in one or more example embodiments, the system intelligence component 602 (e.g., data pre-processing component 602b) identifies one or more new resolution codes based on processing of tagged information. For instance, in one or more example embodiments, the system intelligence component 602 (e.g., data pre-processing component 602b) identifies one or more new root cause based on processing of tagged information. For instance, in one or more example embodiments, the system intelligence component 602 (e.g., data pre-processing component 602b) can aggregate the one or more new recommendations, one or more new resolution codes, and/or one or more new root causes as resolution input for the at least one service case into a database. The database 612 is a cache memory (e.g., a database structure) that dynamically stores the resolution input for the at least one service case. In such exemplary embodiments, the resolution input for the at least one service case is stored based on interval of time and/or asset hierarchy level. In such exemplary embodiments, the resolution input for the at least one service case is stored based on triggering of the event. For instance, in one or more embodiments, the multivariate time series database stores the asset data for one or more intervals of time (e.g., 1 minute to 12 minutes, 1 hour to 24 hours, 1 day to 31 days, 1 month to 12 months, etc.) and/or for one or more asset hierarchy levels (e.g., asset level, asset zone, building level, building zone, plant level, plant zone, industrial site level, etc.). In a non-limiting embodiment, the multivariate time series database stores the asset data for a first interval of time (e.g., 1 hour to 24 hours minutes) for a first asset (e.g., a first asset hierarchy level), for a second interval of time (e.g., 1 day to 31 days) for the first asset, and for a third interval of time (e.g., 1 month to 12 months) for the first asset. Furthermore, in the non-limiting embodiment, the multivariate time series database stores the asset data for the first interval of time (e.g., 1 hour to 24 hours minutes) for all assets in a connected building (e.g., a second asset hierarchy level), for the second interval of time (e.g., 1 day to 31 days) for all the assets in the connected building, and for the third interval of time (e.g., 1 month to 12 months) for the all the assets in the connected building. In the non-limiting embodiment, the multivariate time series database also stores the asset data for the first interval of time (e.g., 1 hour to 24 hours minutes) for all connected buildings within a particular geographic region (e.g., a third asset hierarchy level), for the second interval of time (e.g., 1 day to 31 days) for all connected buildings within the particular geographic region, and for the third interval of time (e.g., 1 month to 12 months) for all connected buildings within the particular geographic region. Additionally, in one or more embodiments, the multivariate time series database stores at least a portion of the asset data associated with two or more variables (e.g., two or more features) associated with the portfolio of assets. As such, in one or more embodiments, the multivariate time series database stores multivariate data (e.g., multivariate time series data) associated with the one or more assets (e.g., the edge devices 412a-412n).

In one or more embodiments, the system intelligence component 602 (e.g., data aggregation component 602a) repeatedly updates data of the database 612 based on the processing of the tagged information. For instance, in one or more example embodiments, the system intelligence component 602 (e.g., data aggregation component 602a) updates a knowledge graph 434 with the resolution input for the at least one service case. In one or more example embodiments, the system intelligence component 602 (e.g., data aggregation component 602a) formats one or more portions. For instance, in one or more example embodiments, the system intelligence component 602 (e.g., data aggregation component 602a) provides a formatted version of the resolution input. For instance, in one or more example embodiments, the system intelligence component 602 (e.g., data aggregation component 602a) provides a formatted version of one or more new recommendations to the database. For instance, in one or more example embodiments, the system intelligence component 602 (e.g., data aggregation component 602a) provides a formatted version of the one or more new resolution codes to the database. For instance, in one or more example embodiments, the system intelligence component 602 (e.g., data aggregation component 602a) provides a formatted version of the one or more new root cause to the database. In some example embodiments, the formatted version of the resolution input is based on one or more defined formats associated with the one or more intervals of time and/or the one or more asset hierarchy levels.

In one or more embodiments, the system intelligence component 602 (e.g., data aggregation component 602a) identifies and/or groups data associated with the resolution input based on a tag associated with the one or more inputs, one or more intervals of time (e.g., one or more reporting intervals of time), the one or more asset hierarchy levels, and/or corresponding variables (e.g., corresponding features and/or attributes). In one or more example embodiments, the system intelligence component 602 (e.g., data aggregation component 602a) employs batching, concatenation of the resolution input. In one or more example embodiments, the system intelligence component 602 (e.g., data aggregation component 602a) employs grouping of the resolution input. In one or more example embodiments, the system intelligence component 602 (e.g., data aggregation component 602a) may batch, concatenate, or group data from the resolution input based on features, attributes, and/or hashtags associated with the resolution input. In one or more example embodiments, the system intelligence component 602 (e.g., data aggregation component 602a) groups data from the resolution input based on corresponding identifiers represented by the hashtags.

In one or more example embodiments, the system intelligence component 602 (e.g., data pre-processing component 602b) is configured to perform data preprocessing with respect to the one or more inputs and/or data stored in the database. In one or more embodiments, the system intelligence component 602 (e.g., data pre-processing component 602b) employs one or more locality-sensitive hashing techniques to identify one or more new recommendations, one or more new resolution codes, and/or one or more new root cause codes for the at least one service case. In some example embodiments, the system intelligence component 602 (e.g., data pre-processing component 602b) can perform natural language processing on the one or more inputs. In one or more example embodiments, the system intelligence component 602 (e.g., data pre-processing component 602b) can identify a specific recommendation from the resolution input based on a category of one or more assets. In one or more example embodiments, the system intelligence component 602 (e.g., data pre-processing component 602b) can identify a specific resolution code from the resolution input based on a category of one or more assets. In one or more example embodiments, the system intelligence component 602 (e.g., data pre-processing component 602b) can identify a specific root cause from the resolution input based on a category of one or more assets. In one or more example embodiments, the system intelligence component 602 (e.g., data aggregation component 602a) can compare the resolution input with stored information in database to avoid duplicate information being stored in the database. In one or more example embodiments, the system intelligence component 602 (e.g., data aggregation component 602a) can identify a duplicate recommendation based on data stored in the database. In one or more example embodiments, the system intelligence component 602 (e.g., data aggregation component 602a) can identify a duplicate resolution code based on data stored in the database. In one or more example embodiments, the system intelligence component 602 (e.g., data aggregation component 602a) can identify a duplicate root cause based on data stored in the database. In one or more example embodiments, the system intelligence component 602 (e.g., data aggregation component 602a) can identify a pattern of the resolution input for the at least one service case. In one or more example embodiments, the pattern can be identification of a frequency of a similar type of one or more new recommendations for the at least one service case. In one or more example embodiments, the pattern can be identification of a frequency of a similar type of one or more new resolution codes for the at least one service case. In one or more example embodiments, the pattern can be identification of a frequency of a similar type of one or more new root causes for the at least one service case. In some example embodiments, the system intelligence component 602 (e.g., data aggregation component 602a) can assess the frequency based on the inputs received from multiple users. In some example embodiments, the pattern can be identification of a most likely root cause for a fault related to the at least one service case. In some example embodiments, the pattern can be identification of the most commonly used details of the at least one service case.

In one or more example embodiments, the system intelligence component 602 (e.g., data aggregation component 602a) organizes the formatted version of the resolution input based on a time series mapping of attributes. For instance, in one or more example embodiments, the system intelligence component 602 (e.g., data aggregation component 602a) employs a hierarchical data format technique to organize the formatted version of the resolution input in the database 612. In one or more example embodiments, the database 612 dynamically stores the resolution input (e.g., one or more new recommendations, one or more resolution codes, and/or one or more root cause codes for the at least one service case) based on type of data presented via a dashboard visualization. In one or more example embodiments, at least a portion of resolution input can be converted into one or more metrics (e.g., a KPI metric, a duty KPI, a duty target KPI). In one or more example embodiments, the one or more metrics can be indicative of performance of one or more users and/or one or more service cases. In one or more example embodiments, the one or more metrics can be used as a feedback to improve relevancy of the one or more service cases. In some example embodiments, the system intelligence component 602 (e.g., recommendations component 602c) utilizes resolution input to provide new service cases to resolve one or more events in the facility. In this regard, in some exemplary embodiments, the system intelligence component 602 (e.g., recommendations component 602c) may utilize new service cases to modify one or more processes in the facility. In this regard, in some exemplary embodiments, the system intelligence component 602 (e.g., recommendations component 602c) may utilize new service cases to change configuration of assets in the facility. In this regard, in some exemplary embodiments, the system intelligence component 602 (e.g., recommendations component 602c) in accordance with the dashboard visualization component 606 may present a notification to allow acceptances of one or more changes done in the facility.

In one or more example embodiments, the governance component 608 is configured to utilize at least a portion of the resolution input as training data for one or more machine learning (ML) models. Also, in some exemplary embodiments, at least a portion of the tagged information received for the at least one service case is employed as training data for one or more machine learning (ML) classifiers. The ML models and/or classifiers process tagged information to identify one or more new recommendations, one or more new resolution codes, and/or one or more new root cause codes for the at least one service case associated with the one or more assets. Further details of governance component 608 is explained in accordance with one or more example embodiments described in the later part of the present disclosure.

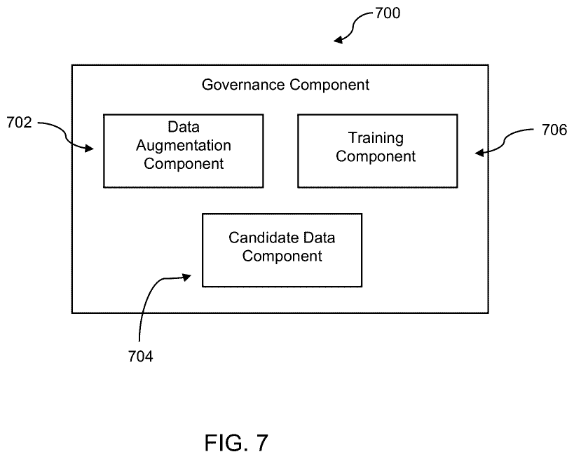

FIG. 7 illustrates a schematic diagram showing an implementation of a governance component, in accordance with one or more example embodiments described herein. In one or more example embodiments, the governance component may be implemented in accordance with the system 600 as described in FIG. 6 of the present disclosure. In one or more example embodiments, the governance component 700 includes a data augmentation component 702, a candidate data component 704, and/or a training component 706. In one or more example embodiments, the data augmentation component 702 performs data augmentation with respect to one or more inputs provided by a worker. In some example embodiments, the data augmentation component 702 performs data augmentation with respect to data stored in the database. In this regard, in one or more example embodiments, the data augmentation component 702 performs data augmentation with respect to tagged information provided by the worker. Further, in some example embodiments, the data augmentation component 702 performs data augmentation with respect to tagged information stored in the database. In this regard, the data augmentation component 702 facilitates identification of one or more new recommendations for at least one service case. Further, the data augmentation component 702 facilitates identification of one or more new resolution codes for at least one service case. Further, the data augmentation component 702 facilitates identification of one or more new root causes for at least one service case. In one or more example embodiments, the data augmentation component 702 can relate the one or more new recommendations with existing recommendations stored in the database. In one or more example embodiments, the data augmentation component 702 can relate the one or more new resolution codes with existing resolution codes stored in the database. In one or more example embodiments, the data augmentation component 702 can relate the one or more new root causes with existing root causes stored in the database. In one or more example embodiments, the data augmentation component 702 can associate at least one service case with one or more new tags and can be stored in the database. In one or more example embodiments, the data augmentation component 702 performs the data augmentation to provide suitable data to train one or more machine learning classifiers. In one or more example embodiments, the data augmentation component 702 employs one or more data augmentation techniques to augment the one or more inputs provided by the worker and/or data stored in the database with a predicted rare event and/or rule weighting. In one or more example embodiments, the data augmentation component 702 assigns the one or more new recommendations, one or more new resolution codes, and/or one or more new root cause codes with weightage. In some example embodiments, the weightage can indicate a likelihood of a relevancy of the one or more new recommendations, one or more new resolution codes, and/or one or more new root cause codes to the at least one service case. In one or more example embodiments, the data augmentation component 702 can identify one or more new recommendations, one or more new resolution codes, and/or one or more new root cause codes to be irrelevant to the at least one service case. In some example embodiments, the data augmentation component 702 can communicate with the dashboard visualization component 606 to generate dashboard visualization data 614 indicative of irrelevancy of the one or more new recommendations, one or more new resolution codes, and/or one or more new root cause codes to the at least one service case. The one or more data augmentation techniques include, for example, a SMOTE technique that employs a KNN technique with respect to data, an ADASYN technique that employs a distribution to weight data, an SVM-SMOTE technique that employs one or more SVMs in combination with the KNN technique, a SMOTE-TOMEK technique that removes data points of a majority class and/or adds data points for a minority class using SMOTE, a boosting based technique (e.g., a SMOTEBoost technique, a RareBoost technique, etc.), a cost sensitive classification technique (e.g., MetaCost, AdaCost, CSB, SSTBoost, etc.), a clustering based classification technique, an over-sampling a rare class technique, a linear regression model technique for increasing minority class samples, and/or another type of data augmentation technique.

In one or more example embodiments, the training component 706 is configured to train one or more machine learning classifiers. For instance, in one or more example embodiments, the training component 706 determines and/or tunes one or more parameters (e.g., one or more hyperparameters, one or more weights, etc.) for one or more learning processes associated with the one or more machine learning classifiers. In an example embodiment where a machine learning classifier is a random forest classifier, the training component 706 determines and/or tunes one or more parameters (e.g., one or more hyperparameters, one or more weights, etc.) during training of the random forest classifier. In another example embodiment, the one or more parameters (e.g., one or more hyperparameters, one or more weights, etc.) includes a parameter associated with a number of processors to be employed by a machine learning classifier, a number of processing trees to be included in a machine learning classifier, a number of split points for a processing tree included in a machine learning classifier, a number of samples to be included in data for a machine learning classifier, a size of a node in a machine learning classifier, a number of random samples to be included in data for a machine learning classifier, and/or one or more other parameters for a machine learning classifier. Based on the one or more parameters (e.g., one or more hyperparameters, one or more weights, etc.) determined and/or tuned by training component 706, in one or more embodiments, the training component 706 trains the respective machine learning classifier to detect presence or absence of one or more new recommendations, one or more new resolution codes, and/or one or more new root cause codes for the at least one service case in the tagged information. In one or more example embodiments, the training component 706 trains and/or generates respective machine learning classifiers for respective defined data signatures. In some example embodiments, the data signatures can correspond to a set of tags. In some example embodiments, the set of tags may comprise tags such as, but not limited to #RecIn, #RecNew. In this regard, in some exemplary embodiments described herein, #RecNew may be indicative of a new recommendation. Further, in some exemplary embodiments described herein, #RecIn maybe indicative of a relevancy of at least one service case. In one or more example embodiments, a trained version of a machine learning classifier is configured with, for example, one or more decision rules, one or more decision trees, a classification type associated with a set of recommendations, a set of root causes, a set of resolution codes, and/or a model score for a particular classification type. In one or more example embodiments, a trained version of a machine learning classifier is correlated with a score (e.g., a quality score, an F1 score, a recall score, a precision score, a correlation score, an MCC score, and/or another type of scoring metric).

In one or more example embodiments, the candidate data component 704 is configured for candidate data classification of one or more inputs. In one or more example embodiments, the candidate data component 704 executes one or more machine learning classifiers to provide a classification of the tagged information corresponding to the one or more inputs. In one or more example embodiments, the candidate data component 704 employs one or more data historians to provide incremental classification with respect to one or more machine learning classifiers. In one or more example embodiments, the candidate data component 704 derives a feature space for an input based on a feature space employed during training of a machine learning classifier associated with the tagged information. In one or more example embodiments, the candidate data component 704 executes a machine learning classifier for a defined input based on parameter obtained during training of the machine learning classifier. In one or more example embodiments, the candidate data component 704 correlates a machine learning classifier for a defined input with a quality score (e.g., a goodness of fit score).

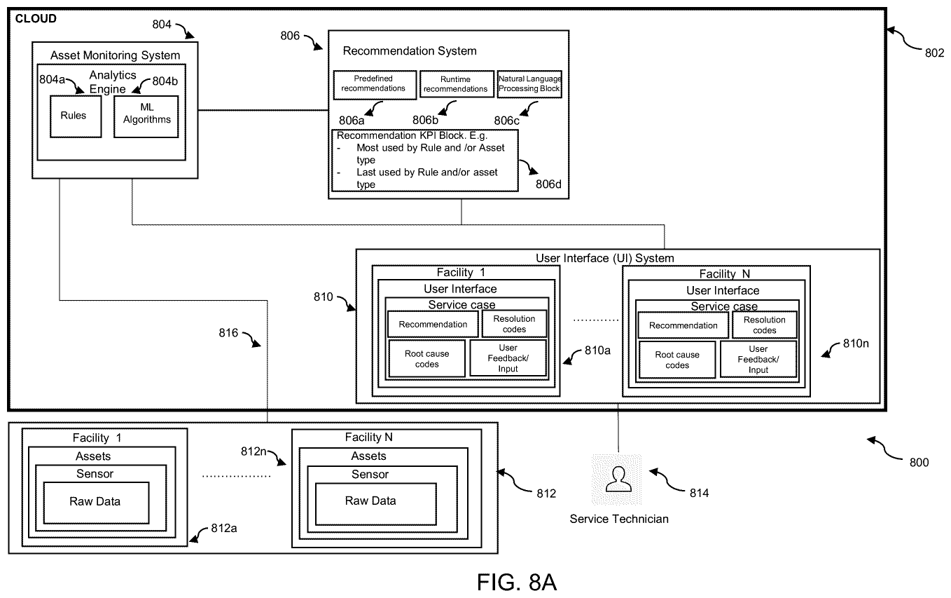

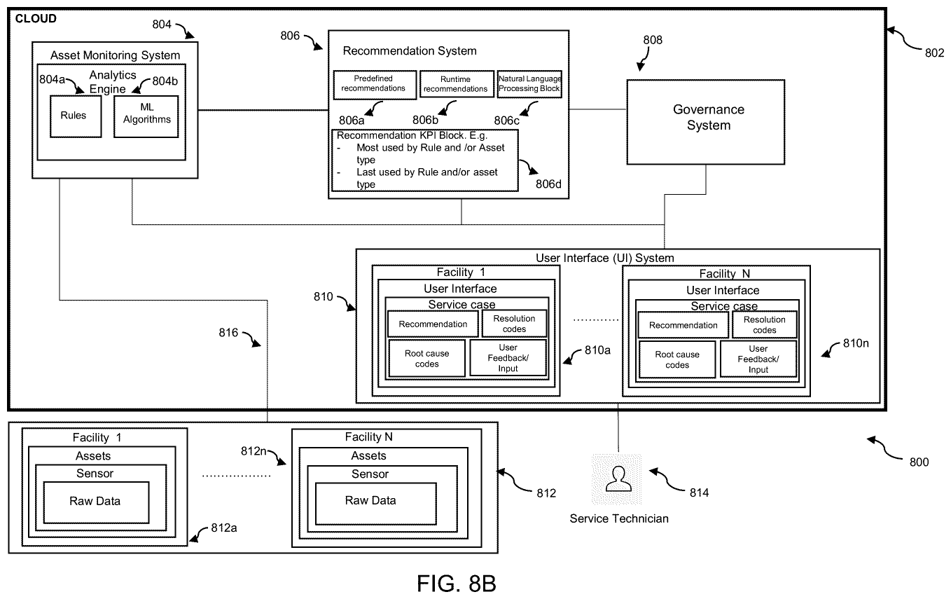

FIG. 8A illustrates a schematic diagram showing an implementation of a facility management system, in accordance with one or more example embodiments described herein. In one or more example embodiments, facility management system 800 may comprise one or more facilities 812a-812n (collectively “facilities 812”). In some example embodiments, the one or more facilities 812a-812n may represent a building or part of a building. In some example embodiments, the one or more facilities 812a-812n may represent an industrial process or part of an industrial process. In some example embodiments, the one or more facilities 812a-812n may represent similar types of facilities. In some example embodiments, the one or more facilities 812a-812n may represent different types of facilities. Further, in some example embodiments, the one or more facilities 812a-812n may include a variety of different assets. In some example embodiments, the one or more facilities 812a-812n may include a variety of different assets, at least some of which are of same type. In an example embodiment, the one or more facilities 812a-812n may include a variety of different assets, at least some of which are of different type.

In one or more example embodiments, one or more facilities 812a-812n may be operably coupled to a cloud 802 via a network 816. In an example embodiment, the network 816 may independently be, for example, a BACnet network, a NIAGARA network, a NIAGARA CLOUD network, or others. Further, in some example embodiments, operational data such as telemetry data and optionally associated metadata may be uploaded to the cloud 802 for processing. In some example embodiments, the operational data may be associated with one or more assets situated in the one or more facilities 812a-812n. In this regard, the operational data may comprise telemetry data with data values along with related time stamps. Further, the operational data may also comprise raw data from one or more sensors situated in the one or more facilities 812a-812n.

In an example embodiment, the cloud 802 may comprise an asset monitoring system 804, a recommendation system 806, and/or a User Interface (UI) system 810. In one or more example embodiments, the asset monitoring system 804 may be configured to monitor the assets in one or more facilities 812a-812n. In one or more example embodiments, the asset monitoring system 804 may be configured to process the operational data received at the cloud 802. In one or more example embodiments, the asset monitoring system 804 may be configured to detect one or more events in one or more facilities 812a-812n based on processing of operational data. In one or more example embodiments, the asset monitoring system 804 may be configured to identify inter-relationship between one or more events in one or more facilities 812a-812n. In one or more example embodiments, the asset monitoring system 804 may comprise an analytics engine. In this regard, the analytics engine may comprise one or more rules 804a and one or more machine learning (ML) algorithms 804b. In some exemplary embodiments, the one or more rules 804a may be generated by a rule engine. In some exemplary embodiments, the rule engine may generate one or more rules based on historic data. In some exemplary embodiments, one or more rules may define threshold values for one or more parameters associated with assets and/or sensors in the facility. In this regard, in some example embodiments, the one or more parameters may be, but not limited to temperature, operational status, duration of operation, voltage, current, flow rate, etc. For example, a rule may comprise instructions to check if zone temperature of Fan Powered Boxes (FPB) is more than setpoint by 3.7° F. In another example, a rule may comprise checking operational status of an asset for a pre-determined time. In this regard, a rule may comprise checking if a reheat valve is closed or open for every 20 minutes. Further, in some examples, the rule may comprise checking if air handling unit (AHU) discharge temperature satisfies a pre-defined threshold or not for a pre-determined time. One or more rules described herein are exemplary only and are not limited to examples described herein.

In some example embodiments, the recommendation system 806 may comprise predefined recommendations 806a, runtime recommendations 806b, natural language processing block 806c, and/or Recommendation Key Performance Indicator (KPI) block 806d. In some example embodiments, the recommendation system 806 in accordance with the asset monitoring system 804 may generate one or more recommendations to address the one or more events in one or more facilities 812a-812n. In some example embodiments, the one or more recommendations may correspond to a service case. In some example embodiments, the one or more recommendations may correspond to details in a service case. In some example embodiments, the predefined recommendations 806a may comprise one or more rules 804a provided by the asset monitoring system 804. In some example embodiments, the predefined recommendations 806a may comprise one or more predefined service cases. In some exemplary embodiments, the predefined recommendations 806a may be based on historic data. In this regard, in some exemplary embodiments, the predefined recommendations 806a may be defined based on one or more resolved service cases in the past.

In some example embodiments, runtime recommendations 806b may comprise one or more recommendations provided by a user in real time. For example, the asset monitoring system 804 may detect an event in a facility (say facility 812a). In response to detection of this event, the recommendation system 806 may generate a service case to address this event. In some example embodiments, the recommendation system 806 may utilize knowledge graphs 434 to generate a service case. In this regard, the recommendation system 806 may generate a service case based on historic data and/or one or more predefined service cases. Further, in some example embodiments, the User Interface (UI) system 810 may be configured to render the service case on a display of a computing device (not shown) associated with a service technician 814. In some example embodiments, the service case rendered on the display may comprise detailed description of the service case. In some example embodiments, the service case may comprise a root cause code. In some example embodiments, the service case may comprise a resolution code. In this regard, in some example embodiments, the detailed description may comprise a recommendation indicative of an action to be taken by the service technician 814. In some example embodiments, the recommendation in the service case may be relevant to the event. In some example embodiments, the recommendation in the service case may not be relevant to the event. In some example embodiments, the recommendation in the service case may not be useful to address the event. In some example embodiments, a part of the recommendation in the service case may be useful to address the event. In this regard, the User Interface (UI) system 810 allows the service technician 814 to provide a feedback on the service case. In some example embodiments, a feedback may be provided with information preceded with a hashtag. In this regard, the feedback may be similar to that of tagged information 604a as described in FIG. 6 of the present disclosure. In some example embodiments, the feedback may indicate a relevancy of the service case to address the event. In some example embodiments, the feedback may indicate a new recommendation that can be used to address the event. In some example embodiments, the feedback may indicate one or more steps undertaken by the service technician 814 to address the event. In some example embodiments, the feedback may indicate credit points provided by the service technician 814 to the service case. In some example embodiments, the feedback may indicate a credit provided by the service technician 814 to a feedback provided by another service technician in a facility. In some example embodiments, the recommendation system 806 may generate a notification in response to receipt of feedback from the service technician 814. In some example embodiments, one or more recommendations of the recommendation system 806 may be dynamically updated based on the feedback provided by the service technician 814. In some example embodiments, the recommendation system 806 may dynamically update knowledge graphs 434. In some example embodiments, the recommendation system 806 may generate a notification in response to updating one or more recommendations.

In some example embodiments, Natural Language Processing (NLP) block 806c is configured to perform natural language processing on the feedback provided by the service technician 814. In this regard, the NLP block 806c may comprise a natural language processing algorithm to perform natural language processing. In some example embodiments, the NLP block is configured to process the feedback to identify a context of the feedback. In some example embodiments, the context may be indicative of a new recommendation. In some example embodiments, the context may be indicative of a new root cause. In some example embodiments, the context may be indicative of a new resolution code.

In some example embodiments, Recommendation Key Performance Indicator (KPI) block 806d may provide KPIs of the one or more recommendations. In this regard, in some example embodiments, Recommendation KPI block 806d may track a frequency of usage of one or more recommendations generated by the recommendation system 806. In some example embodiments, Recommendation KPI block 806d may track a frequency of relevancy of one or more recommendations generated by the recommendation system 806. In some example embodiments, Recommendation KPI block 806d may track a frequency of irrelevancy of one or more recommendations generated by the recommendation system 806. In this regard, in some example embodiments, the Recommendation KPI block 806d may rank one or more recommendations generated by the recommendation system 806. Further, in some example embodiments, the Recommendation KPI block 806d may identify most used recommendations out of one or more recommendations generated by the recommendation system 806. In some example embodiments, the Recommendation KPI block 806d may identify least used recommendations out of one or more recommendations generated by the recommendation system 806. In some example embodiments, the Recommendation KPI block 806d may identify most relevant recommendation for an event out of one or more recommendations generated by the recommendation system 806. In some example embodiments, the Recommendation KPI block 806d may identify most used recommendations out of one or more recommendations generated by the recommendation system 806 for a specific asset model. In some example embodiments, the Recommendation KPI block 806d may identify one or more recommendations as site specific recommendations based on an usage of recommendations in a site.

FIG. 8B illustrates a schematic diagram showing an implementation of a facility management system, in accordance with one or more example embodiments described herein. In accordance with one or more example embodiments, the facility management system described herein may be implemented in accordance with the facility management system 800 as described in FIG. 8A of the present disclosure. In accordance with some example embodiments, the facility management system described herein may be configured to operate similar to that of the facility management system 800 described in one or more example embodiments of FIG. 8A. In some example embodiments, the facility management system described herein may additionally include governance system 808. In one or more example embodiments, the governance system 808 performs data augmentation with respect to feedback provided by a service technician 814. In some example embodiments, the governance system 808 facilitates identification of one or more new recommendations based on the feedback provided by the service technician 814. In some example embodiments, the governance system 808 facilitates identification of one or more new resolution codes based on the feedback provided by the service technician 814. In some example embodiments, the governance system 808 facilitates identification of one or more new root causes based on the feedback provided by the service technician 814. In one or more example embodiments, the governance system 808 can relate the one or more new recommendations with existing recommendations stored in database (not shown). In one or more example embodiments, the governance system 808 identifies suitable data in database (not shown) to train one or more machine learning classifiers.

In one or more example embodiments, the governance system 808 is configured to train one or more machine learning classifiers using the identified data. For instance, in one or more example embodiments, the governance system 808 determines and/or tunes one or more parameters (e.g., one or more hyperparameters, one or more weights, etc.) for one or more learning processes associated with the one or more machine learning classifiers. In an example embodiment where a machine learning classifier is a random forest classifier, the governance system 808 determines and/or tunes one or more parameters (e.g., one or more hyperparameters, one or more weights, etc.) during training of the random forest classifier. In another example embodiment, the one or more parameters (e.g., one or more hyperparameters, one or more weights, etc.) includes a parameter associated with a number of processors to be employed by a machine learning classifier, a number of processing trees to be included in a machine learning classifier, a number of split points for a processing tree included in a machine learning classifier, a number of samples to be included in data for a machine learning classifier, a size of a node in a machine learning classifier, a number of random samples to be included in data for a machine learning classifier, and/or one or more other parameters for a machine learning classifier. Based on the one or more parameters (e.g., one or more hyperparameters, one or more weights, etc.) determined and/or tuned by governance system 808, in one or more embodiments, the governance system 808 trains the respective machine learning classifier to detect presence or absence of one or more new recommendations, one or more new resolution codes, and/or one or more new root cause codes in feedback provided by service technician 814. In one or more example embodiments, the governance system 808 trains and/or generates respective machine learning classifiers for respective defined data signatures. In some example embodiments, the data signatures can correspond to a set of tags. In some example embodiments, the set of tags may comprise tags such as, but not limited to #RecIn, #RecNew. In this regard, in some exemplary embodiments described herein, #RecNew may be indicative of a new recommendation. Further, in some exemplary embodiments described herein, #RecIn maybe indicative of a relevancy of at least one service case. In one or more example embodiments, a trained version of a machine learning classifier is configured with, for example, one or more decision rules, one or more decision trees, a classification type associated with a set of recommendations, a set of root causes, a set of resolution codes, and/or a model score for a particular classification type. In one or more example embodiments, a trained version of a machine learning classifier is correlated with a score (e.g., a quality score, an F1 score, a recall score, a precision score, a correlation score, an MCC score, and/or another type of scoring metric).

In one or more example embodiments, the governance system 808 is configured for candidate data classification of feedback provided by the service technician 814. In one or more example embodiments, the governance system 808 executes one or more machine learning classifiers to provide a classification of the tagged information corresponding to feedback provided by the service technician 814. In one or more example embodiments, the governance system 808 employs one or more data historians to provide incremental classification with respect to one or more machine learning classifiers. In one or more example embodiments, the governance system 808 derives a feature space for an input based on a feature space employed during training of a machine learning classifier associated with the tagged information. In one or more example embodiments, the governance system 808 executes a machine learning classifier for a defined input based on parameter obtained during training of the machine learning classifier. In one or more example embodiments, the governance system 808 correlates a machine learning classifier for a defined input with a quality score (e.g., a goodness of fit score).

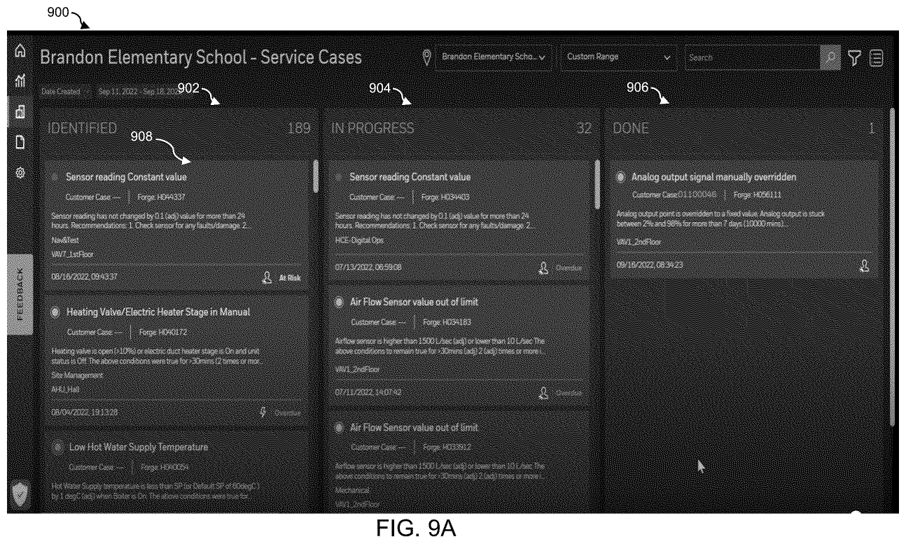

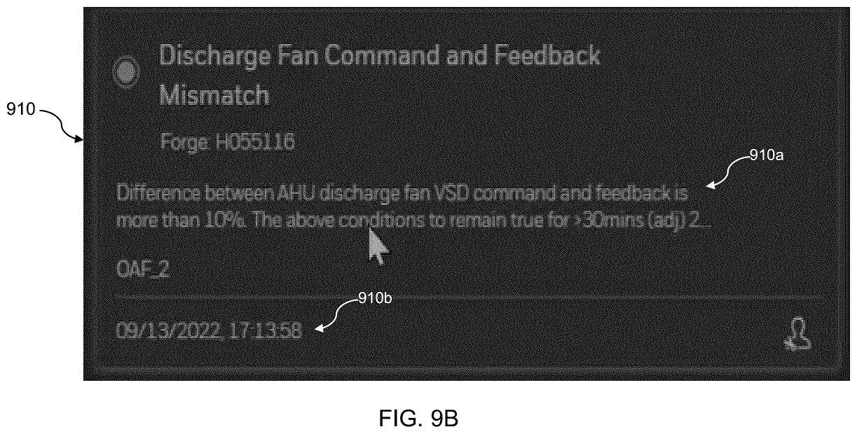

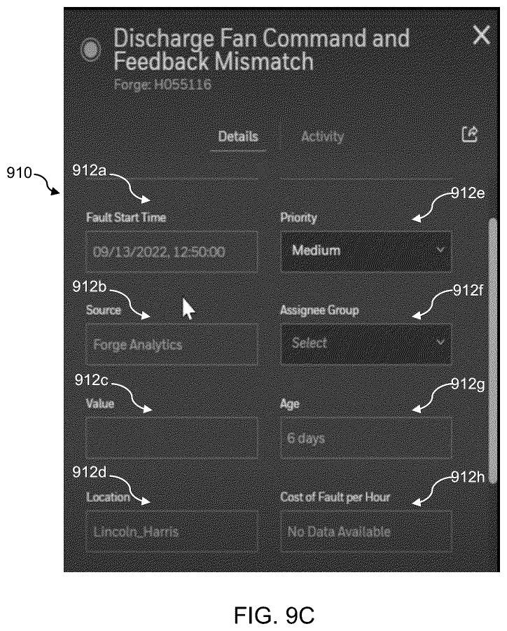

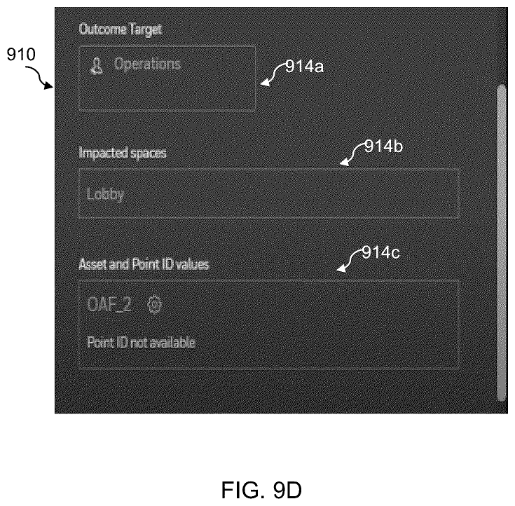

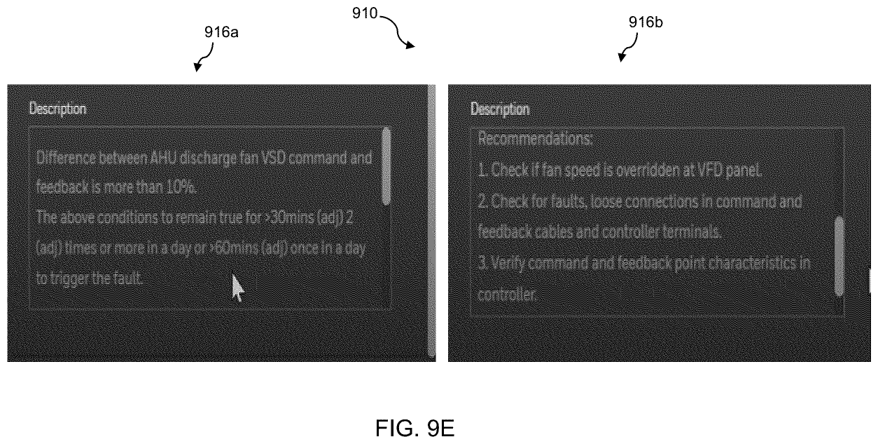

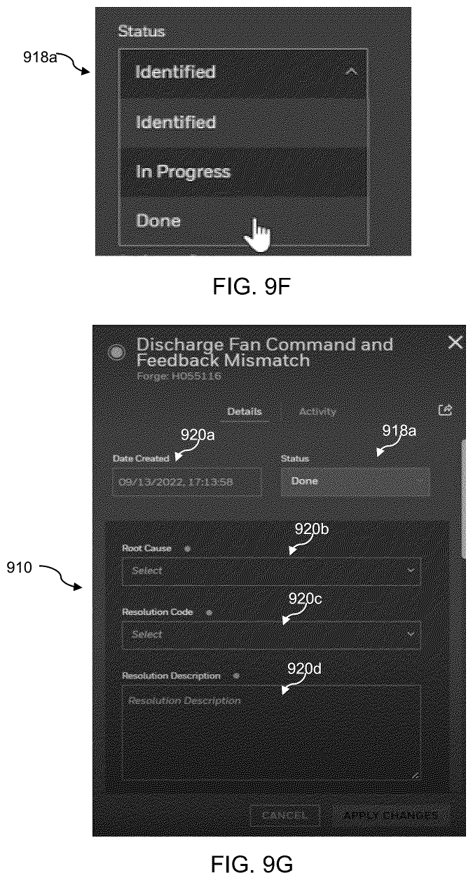

FIG. 9A illustrates a schematic diagram showing an implementation of a user interface, in accordance with one or more example embodiments described herein. In one or more example embodiments, an interface 900 is an electronic interface that is presented via a display of a computing device (not shown). In one or more example embodiments, the dashboard visualization component 606 generates the interface 900. In one or more example embodiments, the interface 900 presents a dashboard visualization data 614. In one or more example embodiments, the dashboard visualization data 614 presented via the interface 900 indicates one or more service cases 902-906. In one or more example embodiments, the interface 900 indicates a status of the one or more service cases 902-906. For example, the status of the one or more service cases 902-906 may be, “identified 902”, “in progress 904”, and/or “done 906”. In this regard, in some instances, “identified 902” service cases may indicate that the service cases are yet to be addressed by a personnel in a facility. In some instances, “in progress 904” service cases may indicate that a personnel in a facility is addressing the service cases. In some instances, “done 906” service cases may indicate that a personnel in a facility has already addressed the service cases. In one or more example embodiments, the interface 900 provides a count of the one or more service cases 902-906. In some example embodiments, the interface 900 provides a priority of the one or more service cases 902-906. In some example embodiments, the one or more service cases 902-906 may be represented in a hierarchical manner. Accordingly, in some example embodiments, the one or more service cases with status as “identified 902” may further comprise a service case 908. In one or more example embodiments, the interface 900 is a user-interactive electronic interface. In this regard, the interface 900 allows a worker to enter one or more inputs for one or more service cases 902-906. In this regard, the interface 900 allows the personnel to change status of the one or more service cases 902-906. Accordingly, the interface 900 is configured to dynamically update status of the one or more service cases 902-906 based on the one or more inputs from the personnel.

FIG. 9B illustrates a schematic diagram showing an implementation of a user interface, in accordance with one or more example embodiments described herein. In one or more example embodiments, an exemplary service case 910 is displayed on an exemplary interface 900 described in accordance with FIG. 9A. In one or more example embodiments, the service case 910 includes a status of the service case 910. In one or more example embodiments, the status of the service case 910 may be, for example, “identified”, “in progress”, and/or “done”. In one or more example embodiments, the service case 910 includes a description 910a indicative of details of the service case 910. In one or more example embodiments, the service case 1100 may include a time stamp and a date 910b on which the service case 910 got created. In one or more example embodiments, the service case 910 presented via the interface 900 is a user-interactive electronic interface that allows a user or worker to enter one or more inputs for one or more service cases and change the status of the one or more service cases.

FIG. 9C illustrates a schematic diagram showing an implementation of a user interface, in accordance with one or more example embodiments described herein. In one or more example embodiments, an interface 900 described in accordance with FIG. 9A presents one or more options 912a-h for the service case 910 described in accordance with FIG. 9B. In one or more example embodiments, one of the one or more options 912a-h may be a fault start time 912a indicative of a timestamp and a date at which the fault occurred. In one or more example embodiments, one of the one or more options 912a-h may be a source 912b indicative of an asset, a department, and/or a portion of the facility in which the fault occurred. In one or more example embodiments, one of the one or more options 912a-h may be value 912c related to the fault and/or the asset in the facility. In one or more example embodiments, one of the one or more options 912a-h may be a location 912d indicative of a position of the asset, location of the department, and/or a portion of the facility in which the fault occurred. In one or more example embodiments, one of the one or more options 912a-h may be a priority level 912e of the service case 910. In one or more example embodiments, the priority level may be one of “low”, “medium”, or “high”. In one or more example embodiments, the priority level is determined based on a risk factor associated with the service case 910. In some example embodiments, the priority level may be based on an impact of the fault on one or more assets in the facility. In one or more example embodiments, one of the one or more options 912a-h may be assignee group 912f. In some example embodiments, assignee group 912f may correspond to one or more personnel responsible for addressing the service case 910. In one or more example embodiments, one of the one or more options 912a-h may be an age 912g indicative of a count of a day, an hour, and/or a minute post occurrence of the fault. In one or more example embodiments, one of the one or more options 912a-h may be a cost of fault per hour 912h. In some example embodiments, the cost of fault per hour 912h may correspond to an estimate of cost required to address the fault. In some example embodiments, the cost of fault per hour 912h may correspond to an estimate of cost that corresponds to a loss due to the fault.

FIG. 9D illustrates a schematic diagram showing an implementation of a user interface, in accordance with one or more example embodiments described herein. In one or more example embodiments, the interface 900 described in accordance with FIG. 9A presents the one or more options 914a-c for the exemplary service case 910. In one or more example embodiments, one of the one or more options 914a-c may be an outcome target 914a. In some example embodiments, an outcome target 914a may correspond to a team of one or more personnel who is responsible for addressing the service case 910. In some example embodiments, the team may be identified based on an analysis of one or more details associated with the fault in the facility. In one or more example embodiments, one of the one or more options 914a-c may be one or more impacted spaces 914b indicative of the one or more assets, departments, and/or a portion of the facility that is likely to get impacted based on the fault occurred. In one or more example embodiments, one of the one or more options 914a-c may be asset and point identification values 914c. In some example embodiments, asset and point identification values 914c may correspond to an identity associated with an asset and/or an operational set point associated with an asset in the facility.

FIG. 9E illustrates a schematic diagram showing an implementation of a user interface, in accordance with one or more example embodiments described herein. In one or more example embodiments, the interface 900 described in accordance with FIG. 9A presents a description 916a and 916b of the exemplary service case 910. In one or more example embodiments, the description 916a can include one or more root causes of a fault. In one or more example embodiments, the description 916b can include one or more recommendations to resolve a fault. In one or more example embodiments one or more recommendations to resolve a fault may be generated based on historic data.

FIG. 9F illustrates a schematic diagram showing an implementation of a user interface, in accordance with one or more example embodiments described herein. In one or more example embodiments, the electronic interface 900 described in accordance with FIG. 9A presents one or more options 918a to modify a status of the exemplary service case 910. In one or more example embodiments, the interface 900 presents a dropdown 918a for the service case 910. In one or more example embodiments, the dropdown 918a includes a list of statuses which may be, for example “identified”, “in progress”, and/or “done”. In one or more example embodiments, a worker may choose a status from the list of the statuses in the dropdown 918a to change the status of the service case 910 via the interface 900.

FIG. 9G illustrates a schematic diagram showing an implementation of a user interface, in accordance with one or more example embodiments described herein. In one or more example embodiments, the electronic interface 900 described in accordance with FIG. 9A presents one or more options 920a-d and 918a. In one or more example embodiments, one of the one or more options 920a may be a date created indicative of a date and a timestamp at which the service case 910 was created. In one or more example embodiments, one of the one or more options 918a may be a status dropdown which is the dropdown as described in accordance with FIG. 9F of the current disclosure. For example, in one or more example embodiments, the interface 900 may be configured to display one or more options 920a-d in response to selecting “done” option from the dropdown 918a which is described in accordance with FIG. 9F of the present disclosure. In one or more example embodiments, one of the one or more options 920b may be a root cause. In one or more example embodiments, the option corresponding to root cause 920b may be displayed as a dropdown. In one or more example embodiments, root cause 920b may be, but not limited to an accidental damage, an aging equipment, a change request, an end of service life, a configuration error, an external influence, a component failure, a process failure, a misapplied product, a temporary work, training, vandalism, water damage, and/or weather damage. In one or more example embodiments, one of the one or more options 920c may be a resolution code. In one or more example embodiments, the option corresponding to the resolution code 920c may be displayed as a dropdown. In one or more example embodiments, the resolution code 920c may be, but not limited to a customer informed of the fault, a software/firmware updated, a temporary fix, an equipment fixed, no fault found, an altered programming, a rule change rejected, a remote analysis, an equipment repaired, an equipment replaced, a rule change requested, case reviewed, a rule adjusted, an altered alarm limits, an equipment calibrated, a contract canceled, a customer canceled call, an equipment cleaned, and/or configuring/tuning a control loop. In one or more example embodiments, one of the one or more options 920d can be a resolution description. In one or more example embodiments, the option corresponding to the resolution description 920d allows a user or worker to enter a recommendation and/or a rule that is not present in the one or more of the root cause 920b and/or the resolution code 920c. In one or more example embodiments, the recommendation and/or the rule entered by the worker can be a description of one or more steps taken by the user or worker to resolve the fault associated with the service case 910. In one or more example embodiments, the description of one or more steps can be preceded by a hashtag indicative of the tagged information. In one or more example embodiments, the recommendation and/or the rule entered by the user or worker can be a new root cause and/or a new resolution code. In one or more example embodiments, the new root cause and/or the new resolution code can be preceded by the hashtag. In some example embodiments, the hashtags may comprise tags such as, but not limited to #RecIn, #RecNew. In this regard, in some exemplary embodiments described herein, #RecNew may be indicative of a new recommendation. Further, in some exemplary embodiments described herein, #RecIn maybe indicative of a relevancy of service case 910.

It may be understood that systems such as, the facility management system 100, the building management system 202, the service case management system 600, and/or the facility management system 800 can be referred interchangeably as facility management system hereinafter throughout the description, for purpose of brevity.

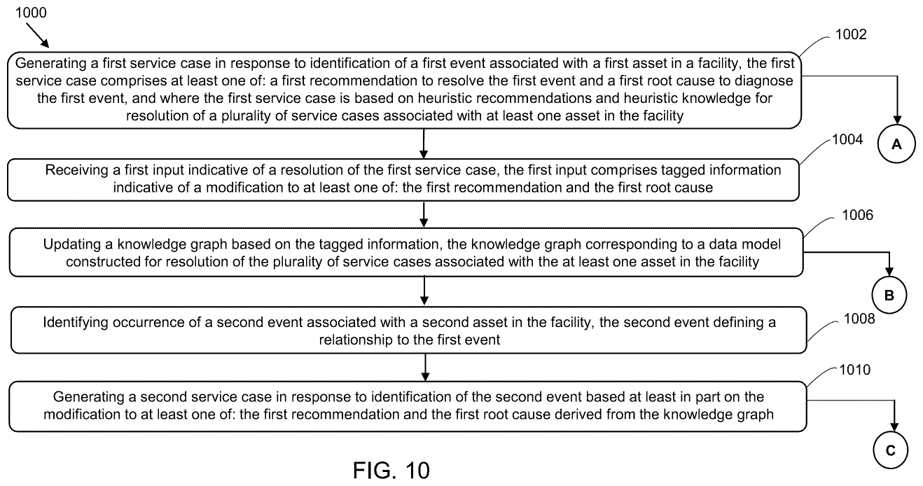

FIG. 10 illustrates a flowchart showing a method described in accordance with some example embodiments described herein. At step 1002, the facility management system 800 includes means, such as asset monitoring system 804 and recommendation system 806 to generate a first service case in response to identification of a first event associated with a first asset in a facility. In some example embodiments, the first service case comprises at least one of: a first recommendation to resolve the first event and a first root cause to diagnose the first event. Further, in some example embodiments, the first service case is based on heuristic recommendations and heuristic knowledge for resolution of a plurality of service cases associated with at least one asset in the facility.

At step 1004, the facility management system 800 includes means, such as User Interface (UI) system 810 to receive a first input indicative of a resolution of a first service case. In some example embodiments, the first input comprises tagged information indicative of a modification to at least one of: a first recommendation and a first root cause.

At step 1006, the facility management system 800 includes means, such as recommendation system 806 to update a knowledge graph 434 based on tagged information. In some example embodiments, the knowledge graph corresponds to a data model constructed for resolution of a plurality of service cases associated with at least one asset in a facility.

At step 1008, the facility management system 800 includes means, such as asset monitoring system 804 to identify occurrence of a second event in a facility. In some example embodiments, the second event can define a relationship to a first event identified at step 1002.

At step 1010, the facility management system 800 includes means, such as asset monitoring system 804 and recommendation system 806 to generate a second service case in response to identification of a second event. In some example embodiments, the second service case is generated based at least in part on a modification to at least one of: a first recommendation and a first root cause derived from a knowledge graph.

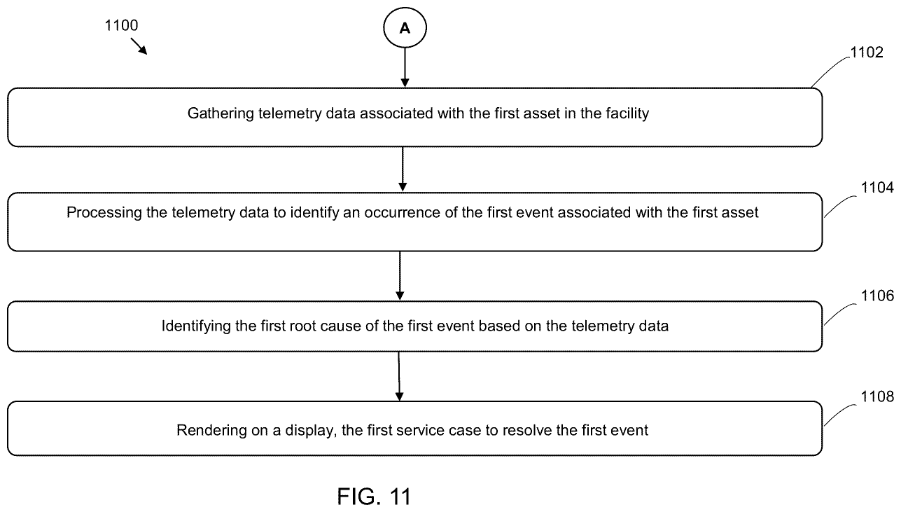

FIG. 11 illustrates a flowchart showing a method described in accordance with some example embodiments described herein. At step 1102, the facility management system 800 includes means, such as asset monitoring system 804 to gather telemetry data associated with a first asset in a facility.

At step 1104, the facility management system 800 includes means, such as asset monitoring system 804 to process telemetry data to identify an occurrence of a first event associated with a first asset.

At step 1106, the facility management system 800 includes means, such as asset monitoring system 804 to identify a first root cause of a first event based on telemetry data. In some example embodiments, the first root cause is at least one of: an accidental damage, an aging equipment, a change request, an end of service life, a configuration error, an external influence, a component failure, a process failure, a misapplied product, a temporary work, training, vandalism, water damage, and weather damage.

At step 1108, the facility management system 800 includes means, such as User Interface (UI) system 810 to render on a display, a first service case to resolve a first event.

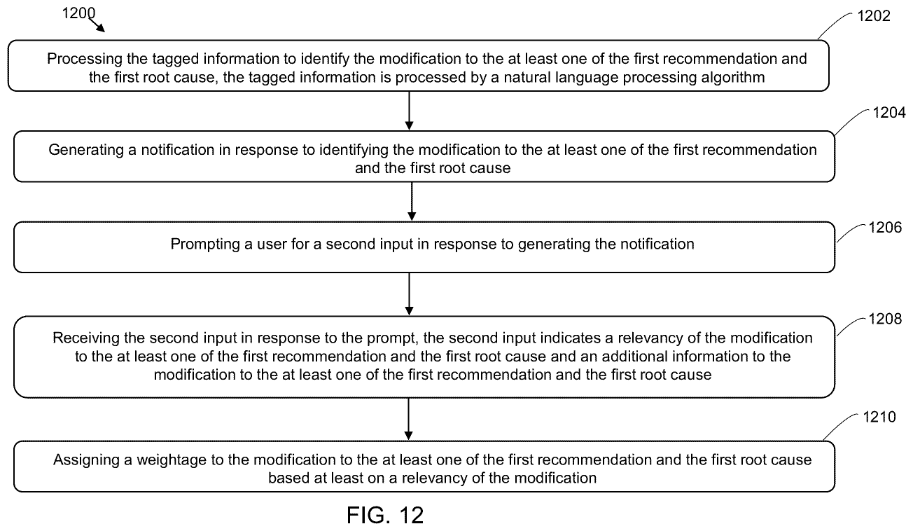

FIG. 12 illustrates a flowchart showing a method described in accordance with some example embodiments described herein. At step 1202, the facility management system 800 includes means, such as recommendation system 806 to process tagged information to identify modification to at least one of a first recommendation and a first root cause. In some example embodiments, the facility management system 800 may also include means, such as natural language processing block 806c to process tagged information. In this regard, natural language processing algorithm of the natural language processing block 806c may process the tagged information to identify modification to at least one of a first recommendation and a first root cause.

At step 1204, the facility management system 800 includes means, such as recommendation system 806 to generate a notification in response to identifying a modification to at least one of a first recommendation and a first root cause.

At step 1206, the facility management system 800 includes means, such as recommendation system 806 and User Interface (UI) system 810 to prompt a user for a second input in response to generating a notification.

At step 1208, the facility management system 800 includes means, such as recommendation system 806 and User Interface (UI) system 810 to receive a second input in response to a prompt. In some example embodiments, the second input indicates a relevancy of the modification to the at least one of the first recommendation and the first root cause. In some example embodiments, the second input indicates an additional information to the modification to the at least one of the first recommendation and the first root cause.

At step 1210, the facility management system 800 includes means, such as recommendation system 806 and User Interface (UI) system 810 to assign a weightage to the modification to at least one of a first recommendation and a first root cause based at least on a relevancy of the modification.

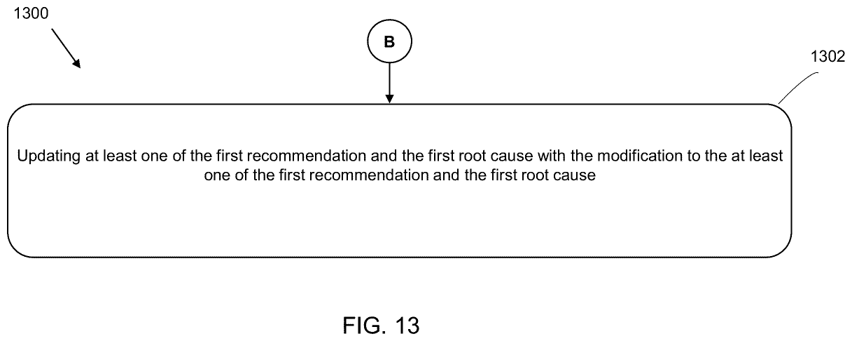

FIG. 13 illustrates a flowchart showing a method described in accordance with some example embodiments described herein. At step 1302, the facility management system 800 includes means, such as recommendation system 806 to update at least one of a first recommendation and a first root cause with a modification to at least one of the first recommendation and the first root cause.

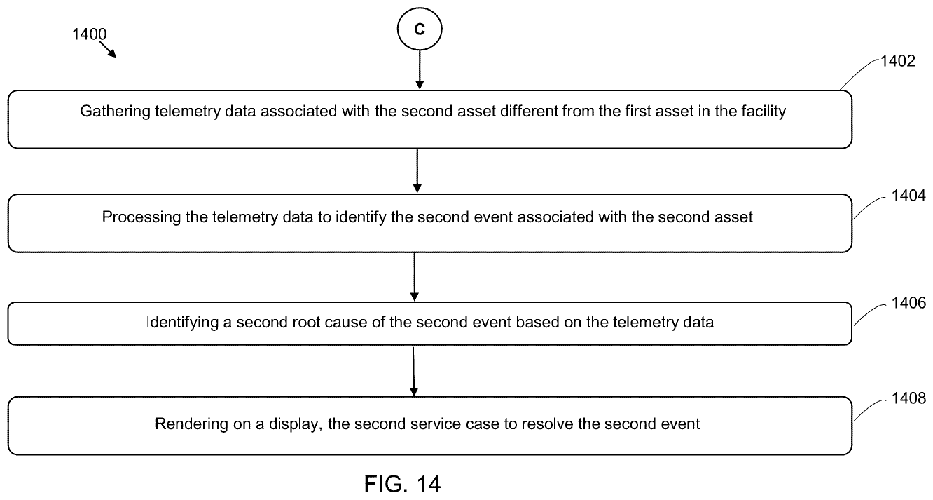

FIG. 14 illustrates a flowchart showing a method described in accordance with some example embodiments described herein. At step 1402, the facility management system 800 includes means, such as asset monitoring system 804 to gather telemetry data associated with a second asset different from a first asset in a facility.

At step 1404, the facility management system 800 includes means, such as asset monitoring system 804 to process telemetry data to identify a second event associated with a second asset.

At step 1406, the facility management system 800 includes means, such as asset monitoring system 804 to identify a second root cause of a second event based on telemetry data. In some example embodiments, the second root cause is at least one of: an accidental damage, an aging equipment, a change request, an end of service life, a configuration error, an external influence, a component failure, a process failure, a misapplied product, a temporary work, training, vandalism, water damage, and weather damage.

At step 1408, the facility management system 800 includes means, such as User Interface (UI) system 810 to render on a display, a second service case to resolve a second event.

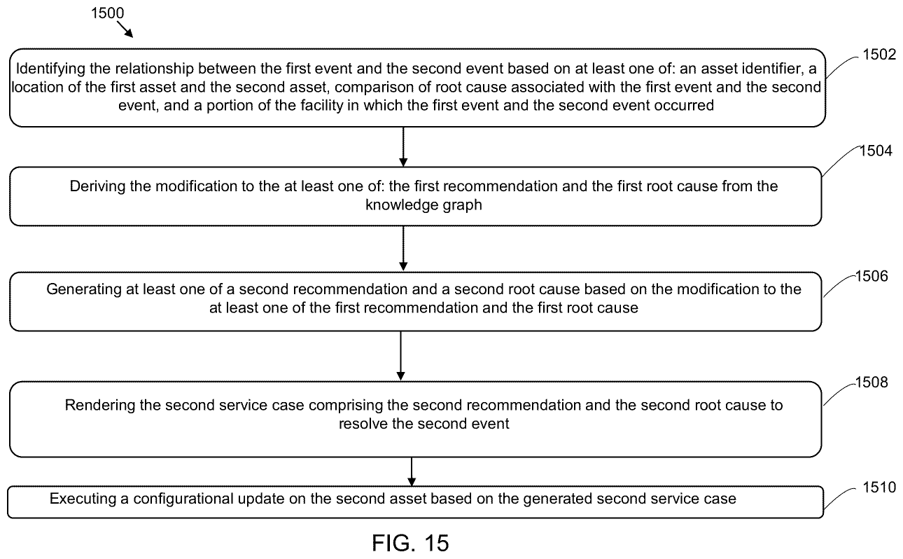

FIG. 15 illustrates a flowchart showing a method described in accordance with some example embodiments described herein. At step 1502, the facility management system 800 includes means, such as asset monitoring system 804 and recommendation system 806 to identify a relationship between the first event and the second event. The relationship is based on at least one of: an asset identifier, a location of the first asset and the second asset, comparison of root cause associated with the first event and the second event, and a portion of the facility in which the first event and the second event occurred.

At step 1504, the facility management system 800 includes means, such as recommendation system 806 to derive a modification to at least one of: a first recommendation and a first root cause from a knowledge graph.

At step 1506, the facility management system 800 includes means, such as recommendation system 806 to generate at least one of a second recommendation and a second root cause based on a modification to at least one of a first recommendation and a first root cause.

At step 1508, the facility management system 800 includes means, such as User Interface (UI) system 810 to render a second service case comprising a second recommendation and a second root cause to resolve a second event.

At step 1510, the facility management system 800 includes means, such as asset monitoring system 804 and recommendation system 806 to execute a configurational update on the second asset based on the generated second service case.

Many modifications and other embodiments of the inventions set forth herein will come to mind to one skilled in the art to which these inventions pertain having the benefit of teachings presented in the foregoing descriptions and the associated drawings. Although the figures only show certain components of the apparatus and systems described herein, it is understood that various other components may be used in conjunction with the supply management system. Therefore, it is to be understood that the inventions are not to be limited to the specific embodiments disclosed and that modifications and other embodiments are intended to be included within the scope of the appended claims. Moreover, the steps in the method described above may not necessarily occur in the order depicted in the accompanying diagrams, and in some cases one or more of the steps depicted may occur substantially simultaneously, or additional steps may be involved. Although specific terms are employed herein, they are used in a generic and descriptive sense only and not for purposes of limitation.

What is claimed is:

1. A method comprising:
generating a first service case in response to identification of a first event associated with a first asset in a facility, wherein the first service case comprises at least one of: a first recommendation to resolve the first event and a first root cause to diagnose the first event, and wherein the first service case is based on heuristic recommendations and heuristic knowledge for resolution of a plurality of service cases associated with at least one asset in the facility;
receiving a first input indicative of a resolution of the first service case, wherein the first input comprises tagged information indicative of a modification to at least one of: the first recommendation and the first root cause;
updating a knowledge graph based on the tagged information, the knowledge graph corresponding to a data model constructed for resolution of the plurality of service cases associated with the at least one asset in the facility;
identifying occurrence of a second event associated with a second asset in the facility, the second event defining a relationship to the first event; and
generating a second service case in response to identification of the second event based at least in part on the modification to at least one of: the first recommendation and the first root cause derived from the knowledge graph.

2. The method of claim 1, wherein the generating the first service case comprises:
gathering telemetry data associated with the first asset in the facility;
processing the telemetry data to identify an occurrence of the first event associated with the first asset;
identifying the first root cause of the first event based on the telemetry data, wherein the first root cause is at least one of: an accidental damage, an aging equipment, a change request, an end of service life, a configuration error, an external influence, a component failure, a process failure, a misapplied product, a temporary work, training, vandalism, water damage, and weather damage; and
rendering on a display, the first service case to resolve the first event.

3. The method of claim 1, further comprising:
processing the tagged information to identify the modification to the at least one of the first recommendation and the first root cause, wherein the tagged information is processed by a natural language processing algorithm.

4. The method of claim 1, further comprising:
generating a notification in response to identifying the modification to the at least one of the first recommendation and the first root cause;
prompting a user for a second input in response to generating the notification; and
receiving the second input in response to the prompt, wherein the second input indicates a relevancy of the modification to the at least one of the first recommendation and the first root cause and an additional information to the modification to the at least one of the first recommendation and the first root cause.

5. The method of claim 4, further comprises:
assigning a weightage to the modification to the at least one of the first recommendation and the first root cause based at least on a relevancy of the modification.

6. The method of claim 1, wherein updating the knowledge graph based on the tagged information further comprises:
updating at least one of the first recommendation and the first root cause with the modification to the at least one of the first recommendation and the first root cause.

7. The method of claim 1, wherein identifying occurrence of the second event in the facility comprises:
gathering telemetry data associated with the second asset different from the first asset in the facility;
processing the telemetry data to identify the second event associated with the second asset;
identifying a second root cause of the second event based on the telemetry data, wherein the second root cause is at least one of: an accidental damage, an aging equipment, a change request, an end of service life, a configuration error, an external influence, a component failure, a process failure, a misapplied product, a temporary work, training, vandalism, water damage, and weather damage; and
rendering on a display, the second service case to resolve the second event.

8. The method of claim 1, further comprises:
identifying the relationship between the first event and the second event based on at least one of: an asset identifier, a location of the first asset and the second asset, comparison of root cause associated with the first event and the second event, and a portion of the facility in which the first event and the second event occurred.

9. The method of claim 1, further comprises:
deriving the modification to the at least one of: the first recommendation and the first root cause from the knowledge graph;
generating at least one of a second recommendation and a second root cause based on the modification to the at least one of the first recommendation and the first root cause; and
rendering the second service case comprising the second recommendation and the second root cause to resolve the second event.

10. The method of claim 1, further comprises:
executing a configurational update on the second asset based on the generated second service case.

11. A system comprising:
one or more processors; and
a memory communicatively coupled to the processor, wherein the memory comprises one or more instructions which when executed by the processor cause the processor to:
generate a first service case in response to identification of a first event associated with a first asset in a facility, wherein the first service case comprises at least one of: a first recommendation to resolve the first event and a first root cause to diagnose the first event, and wherein the first service case is based on heuristic recommendations and heuristic knowledge for resolution of a plurality of service cases associated with at least one asset in the facility;
receive a first input indicative of a resolution of the first service case, wherein the first input comprises tagged information indicative of a modification to at least one of: the first recommendation and the first root cause;
update a knowledge graph based on the tagged information, the knowledge graph corresponding to a data model constructed for resolution of the plurality of service cases associated with the at least one asset in the facility;
identify occurrence of a second event associated with a second asset in the facility, the second event defining a relationship to the first event; and
generate a second service case in response to identification of the second event based at least in part on the modification to at least one of: the first recommendation and the first root cause derived from the knowledge graph.

12. The system of claim 11, wherein the processor is further configured to:
gather telemetry data associated with the first asset in the facility;
process the telemetry data to identify an occurrence of the first event associated with the first asset;
identify the first root cause of the first event based on the telemetry data, wherein the first root cause is at least one of: an accidental damage, an aging equipment, a change request, an end of service life, a configuration error, an external influence, a component failure, a process failure, a misapplied product, a temporary work, training, vandalism, water damage, and weather damage; and
render on a display, the first service case to resolve the first event.

13. The system of claim 11, wherein the processor is further configured to:
process the tagged information to identify the modification to the at least one of the first recommendation and the first root cause, wherein the tagged information is processed by a natural language processing algorithm.

14. The system of claim 11, wherein the processor is further configured to:
generate a notification in response to identifying the modification to the at least one of the first recommendation and the first root cause;
prompt a user for a second input in response to generating the notification; and
receive the second input in response to the prompt, wherein the second input indicates a relevancy of the modification to the at least one of the first recommendation and the first root cause and an additional information to the modification to the at least one of the first recommendation and the first root cause.

15. The system of claim 11, wherein the processor is further configured to:
assign a weightage to the modification to the at least one of the first recommendation and the first root cause based at least on a relevancy of the modification.

16. The system of claim 11, wherein the processor is further configured to:
gather telemetry data associated with the second asset different from the first asset in the facility;
process the telemetry data to identify the second event associated with the second asset;
identify a second root cause of the second event based on the telemetry data, wherein the second root cause is at least one of: an accidental damage, an aging equipment, a change request, an end of service life, a configuration error, an external influence, a component failure, a process failure, a misapplied product, a temporary work, training, vandalism, water damage, and weather damage; and
render on a display, the second service case to resolve the second event.

17. The system of claim 11, wherein the processor is further configured to:
identify the relationship between the first event and the second event based on at least one of: an asset identifier, a location of the first asset and the second asset, comparison of root cause associated with the first event and the second event, and a portion of the facility in which the first event and the second event occurred.

18. The system of claim 11, wherein the processor is further configured to:
derive the modification to the at least one of: the first recommendation and the first root cause from the knowledge graph;
generate at least one of a second recommendation and a second root cause based on the modification to the at least one of the first recommendation and the first root cause; and
render the second service case comprising the second recommendation and the second root cause to resolve the second event.

19. The system of claim 11, wherein the processor is further configured to:
executing a configurational update on the second asset based on the generated second service case.

20. A computer program product comprising at least one computer-readable storage medium having program instructions embodied thereon, the program instructions executable by a processor to cause the processor to:
generate a first service case in response to identification of a first event associated with a first asset in a facility, wherein the first service case comprises at least one of: a first recommendation to resolve the first event and a first root cause to diagnose the first event, and wherein the first service case is based on heuristic recommendations and heuristic knowledge for resolution of a plurality of service cases associated with at least one asset in the facility;
receive a first input indicative of a resolution of the first service case, wherein the first input comprises tagged information indicative of a modification to at least one of: the first recommendation and the first root cause;
update a knowledge graph based on the tagged information, the knowledge graph corresponding to a data model constructed for resolution of the plurality of service cases associated with the at least one asset in the facility;
identify occurrence of a second event associated with a second asset in the facility, the second event defining a relationship to the first event; and
generate a second service case in response to identification of the second event based at least in part on the modification to at least one of: the first recommendation and the first root cause derived from the knowledge graph.
